(19) United States
(12) Patent Application Publication
(10) Pub. No.: US 2026/0249269 A1
(43) Pub. Date: Aug. 27, 2026

(54) DILUTE MATERIAL RECOVERY SYSTEM BASED ON MICROWAVE-BASED REGENERATION

(71) Applicant: CarbonStellar LLC, Berkeley, CA (US)

(72) Inventor: Tae Hwan LIM, Berkeley, CA (US)

(73) Assignee: CarbonStellar LLC, Berkeley, CA (US)

(21) Appl. No.: 19/550,209

(22) Filed: Feb. 25, 2026

Related U.S. Application Data
(60) Provisional application No. 63/969,269, filed on Jan. 27, 2026.
(60) Provisional application No. 63/763,042, filed on Feb. 25, 2025.

(51) Int. Cl. B01J 20/28; B01D 53/04; B01J 20/30; B01J 20/34

(52) U.S. Cl. CPC B01J 20/28042; B01D 53/0446; B01D 53/0454; B01J 20/3092; B01J 20/3441; B01D 2253/34; B01D 2257/504; B01D 2259/40094

(57) ABSTRACT

According to examples, a sorbent structure may include a sorbent material formed to have a 3-dimensional shape including a plurality of protrusions. The sorbent material may adsorb a compound from ambient air that passes through the sorbent structure and may desorb the adsorbed compound in response to electromagnetic energy being radiated at the sorbent material. The plurality of protrusions may distribute the electromagnetic energy into the sorbent structure to reduce reflection of the electromagnetic energy incident on the sorbent structure and may evenly dissipate the incident electromagnetic energy within the sorbent structure.

### BACKGROUND

Dilute material recovery or separation technologies are directed to devices that remove or separate material from the environment. These devices may recover or separate various types of diluted material, such as contaminants, volatile organic compounds (VOC), water, or the like, from mixed gas streams including ambient air, flue gas, process gas, or the like. For instance, direct air capture (DAC) devices extract carbon dioxide (CO₂) directly from the ambient air. Some DAC devices use sorbents or solvents to capture the CO₂. In many instances, the sorbents or solvents may be reused by regenerating them using external energy sources to desorb the recovered material from the sorbents or solvents.

### BRIEF DESCRIPTION OF THE DRAWINGS

Features of the present disclosure are illustrated by way of example and not limited in the following figure(s), in which like numerals indicate like elements, in which:

FIG. 1 depicts a diagram of an example dilute material recovery system;

FIG. 2A depicts a diagram of an example apparatus having a rectangular shape;

FIG. 2B depicts a cross-sectional side view of the example apparatus including sorbent material formed to have a plurality of protrusions;

FIG. 2C depicts a cross-sectional side view of an example apparatus including a plurality of protrusions disposed on two sides of the sorbent structure;

FIG. 2D depicts a cross-sectional side view of an example apparatus including rounded tips on the plurality of protrusions;

FIG. 2E depicts a cross-sectional side view of an example apparatus including a reflective material;

FIG. 2F depicts a 3-dimensional perspective view of an example apparatus in which the plurality of protrusions have a pyramid shape;

FIG. 2G depicts a 3-dimensional perspective view of an example apparatus in which the plurality of protrusions have a triangular prism shape;

FIG. 3A depicts 3-dimensional perspective view of an example sorbent regenerator to regenerate sorbent material disposed in the sorbent structure;

FIG. 3B depicts a diagram of an example energy source that emits electromagnetic energy at the sorbent structure;

FIG. 4 depicts a block diagram of an example dilute material recovery system that continuously circulates a plurality of sorbent structures for regeneration through a plurality of modules having a regenerator and an air contactor;

FIG. 5 depicts a block diagram of an example dilute material recovery system that includes an array of cells;

FIG. 6 depicts a diagram of an example continuous flow dilute material recovery system that includes a tube that connects an air contactor and a regeneration chamber;

FIG. 7A depicts a side view of an example sorbent structure having sorbent material shaped in a spherical shape;

FIG. 7B depicts a 3-dimensional perspective view of an example sorbent structure having sorbent material shaped in a cylindrical shape;

FIG. 7C depicts a cross-sectional view of a sorbent structure that allows airflow in one direction or axis;

FIG. 7D depicts a cross-sectional view of a sorbent structure that allows airflow in multiple directions;

FIG. 7E depicts a partial 3-dimensional perspective view of a sorbent structure having a capped end in a tube under vacuum;

FIG. 7F depicts a 3-dimensional perspective view of a stacked group of a plurality of sorbent structures.

FIG. 8A depicts a 3-dimensional perspective view of a sorbent structure having a monolith support structure;

FIG. 8B depicts a 3-dimensional perspective view of a sorbent structure having functionalized fibers with variable fiber density;

FIG. 8C depicts a side view of sorbent structures having various shapes;

FIG. 8D depicts a 3-dimensional perspective view of a sorbent structure having a spiral-wound membrane or mesh;

FIG. 8E depicts a cross-sectional view of sorbent material and sorbent structures in a passage of a tube;

FIG. 8F depicts a 3-dimensional perspective view of a tube at a regeneration chamber having an array of membranes that allows a flow of solvent;

FIG. 9A depicts a 3-dimensional perspective view of a panel shaped sorbent structure;

FIG. 9B depicts a 3-dimensional perspective view of example panel shaped sorbent structures including a plurality of cylindrical shaped sorbent structures;

FIG. 9C depicts a cross-sectional side view of an example panel shaped sorbent structure formed using a tray;

FIG. 10 depicts a diagram of example sorbent regeneration chambers having an elliptical shape;

FIG. 11 depicts a diagram of an example sorbent regeneration chamber having multiple cavities connected in series;

FIG. 12 depicts a 3-dimensional perspective view of example sorbent regeneration chambers having a round shape;

FIG. 13 depicts a 3-dimensional perspective view of an example sorbent regeneration chamber having a rectangular shape;

FIG. 14 depicts a 3-dimensional perspective view of an example solvent-based continuous flow dilute material recovery system;

FIG. 15A depicts a 3-dimensional perspective view of the example sorbent regenerator having resonant cavity assembly;

FIG. 15B depicts a side view of the sorbent regenerator depicted in FIG. 15A;

FIG. 16 depicts a side view of an example sorbent regenerator having a resonant cavity assembly in which an input waveguide is in a horizontal position;

FIG. 17 depicts a diagram of an example sorbent regeneration chamber having a flared surface;

FIG. 18A depicts a side view of an example sorbent regenerator having vacuum sealing doors;

FIG. 18B depicts a cross-sectional view of an example sorbent regeneration chamber with vacuum sealing doors;

FIG. 19 depicts a side view of an example sorbent regenerator that includes a vacuum pump;

FIG. 20A depicts a diagram of an example modular sorbent regenerator including a sorbent regenerator having a single-mode cavity;

FIG. 20B depicts a diagram of an example modular sorbent regenerator including a sorbent regenerator and a sorbent feeding mechanism;

FIG. 20C depicts a diagram of an example modular sorbent regenerator having multiple sorbent regenerators connected in series;

FIG. 21 depicts a diagram of an example modular sorbent regenerator that modulates feed rates of sorbent structures;

FIG. 22 depicts a diagram of an example modular sorbent regenerator including a plurality of sorbent regenerators connected in a multi-cell configuration, in which each cell is tuned for a different input frequency;

FIG. 23 depicts a diagram of an example modular sorbent regenerator that includes multiple sorbent regenerators and a spacer disposed between adjacent sorbent structures to maintain an air/vacuum gap to minimize electromagnetic power leaks;

FIG. 24A depicts a 3-dimensional perspective view of an example feeding mechanism that includes a rotary feedline to move sorbent structures;

FIG. 24B depicts a 3-dimensional perspective view of an example feeding mechanism that includes an angled feedline to move sorbent structures using gravitational feed;

FIG. 24C depicts a 3-dimensional perspective view of an example feeding mechanism that includes a linear actuator to move sorbent structures;

FIG. 25 depicts a block diagram of an example multi-cell sorbent regenerator including a plurality of cell arrays, and including circulators and RF switches to re-direct reflected power to cells in adjacent arrays;

FIG. 26 depicts a diagram of an example multi-cell sorbent regenerator including a plurality cell arrays, and including power combiners to re-direct reflected power to cells in adjacent arrays;

FIG. 27A depicts a 3-dimensional perspective view of an example sorbent regeneration chamber having a rectangular waveguide regeneration chamber;

FIG. 27B depicts a diagram of an example curved sorbent structure for a waveguide sorbent regeneration chamber.

FIG. 28A depicts a block diagram of an example sorbent regenerator having a waveguide regeneration chamber and an input power source;

FIG. 28B depicts a block diagram of an example sorbent regenerator having a waveguide regeneration chamber and multiple input power sources;

FIG. 28C depicts a block diagram of an example sorbent regenerator having a waveguide regeneration chamber with a moving short;

FIG. 29A depicts a 3-dimensional perspective view of an example waveguide regeneration chamber;

FIG. 29B depicts a side view of an example waveguide regeneration chamber that includes vacuum-compatible doors for the sorbent structure;

FIG. 30A depicts a 3-dimensional perspective view of an example waveguide regeneration chamber that includes a perforated wall for ambient airflow;

FIG. 30B depicts a side view of an example waveguide regeneration chamber that includes a perforated wall;

FIG. 30C depicts a side view of an example waveguide regeneration chamber that includes air contactor doors for a perforated wall;

FIG. 30D depicts a side view of an example waveguide regeneration chamber that includes air contactor doors for a partially perforated wall;

FIG. 31 depicts a 3-dimensional perspective view of an example waveguide regeneration chamber that includes a moving short for tuning the rectangular waveguide;

FIG. 32A depicts a diagram of an example sorbent regenerator having a waveguide regeneration chamber, in which a plurality of vacuum lines are connected near a resonant cavity;

FIG. 32B depicts a diagram of an example stacked sorbent regenerator having a plurality of waveguide regeneration chambers stacked together, in which a plurality of vacuum lines are connected near a resonant cavity;

FIG. 33 depicts a diagram illustrating an example power control scheme for a sorbent regenerator having a waveguide regeneration chamber, including input signal control for multiple power input ports;

FIG. 34 depicts a diagram illustrating an example power control scheme for a sorbent regenerator having a waveguide regeneration chamber that includes multiple power input ports, based on phase cycling;

FIG. 35 depicts a 3-dimensional perspective view of an example sorbent regenerator that includes multiple stacked waveguides;

FIG. 36A depicts a diagram of an example sorbent regenerator having an antenna array and a heat map representative of the energy distribution in the regeneration chamber;

FIG. 36B depicts a diagram of an example antenna array having two antennas around a sorbent structure;

FIG. 36C depicts a diagram of an example antenna array having three antennas surrounding a sorbent structure;

FIG. 36D depicts a diagram of an example antenna array having four antennas surrounding a sorbent structure;

FIG. 36E depicts a diagram of an example antenna array having six antennas surrounding a group of four sorbent structures; and

FIG. 37 depicts a diagram of an example sorbent regenerator having a helix antenna and a heat map representative of the energy distribution in the sorbent structure.

### DETAILED DESCRIPTION

For simplicity and illustrative purposes, the principles of the present disclosure are described by referring mainly to examples thereof. In the following description, numerous specific details are set forth in order to provide an understanding of the examples. It will be apparent, however, to one of ordinary skill in the art, that the examples may be practiced without limitation to these specific details. In some instances, well known methods and/or structures have not been described in detail so as not to unnecessarily obscure the description of the examples. Furthermore, the examples may be used together in various combinations.

Throughout the present disclosure, the terms "a" and "an" are intended to denote one of a particular element or multiple ones of a particular element. As used herein, the term "includes" means includes but not limited to, the term "including" means including but not limited to. The term "based on" may mean based in part on.

Dilute material removal or separation is a technique for removing resources or contaminants from ambient air. In some examples, devices directed to dilute material removal or separation may use chemical media, such as solid sorbents or liquid solvents, to capture the dilute materials from ambient air. These devices may be used in various types of applications, such as for CO₂ capture, water harvesting from ambient air, volatile organic compound (VOC) removal, and/or the like. Once the chemical media is saturated with the captured resources or contaminants, the sorbents or solvents may be regenerated for reuse. Sorbent regeneration requires a heat source to heat the sorbents. In some examples, RF technology may be used as the heat source for sorbent regeneration.

For purposes of illustration and ease of explanation, the present disclosure will refer to direct air capture (DAC) for capturing CO₂ from ambient air. It should be understood, however, that the present disclosure is not limited to CO₂, and may be applicable for capturing various types of diluted material, such as contaminants, volatile organic compounds (VOC), water, or the like, from mixed gas streams including ambient air, flue gas or the like.

DAC is a technique for removing contaminants directly from the atmosphere. DAC techniques have been used for CO₂ removal from the atmosphere in an effort to battle climate change. Unlike other types of carbon capture and storage techniques that capture pollutants at the source of the emission such as power plants or industrial facilities, DAC removes contaminants directly from ambient air.

DAC may use different types of media to capture the CO₂. Two main types of media used in DAC systems are solid sorbents and liquid solvents. In the case of solid sorbent-based DAC, the sorbent acts like a physical filter. Particularly, the sorbent chemically binds with CO₂ molecules as air makes contact with the sorbent. If solvents are used, CO₂-capturing moieties may be dissolved or suspended in aqueous or non-aqueous solutions to chemically bind with CO₂ molecules upon contacting the air.

After the CO₂ is captured, the saturated sorbent or solvent is normally regenerated for reuse by stripping the sorbent or solvent of the captured CO₂. The desorbing of CO₂ from the sorbent may produce a purified stream of CO₂ when the sorbent is heated in a vacuum, such as through a temperature-vacuum swing (TVS) process. During a TVS process, the CO₂ saturated sorbents are heated to a relatively high temperature, about 100 ºC, under vacuum. Separating CO₂ from solvent may require relatively higher temperatures, close to 900 ºC. A concern associated with conventional DAC systems, including both sorbent and solvent-based processes, however, is the relatively high energy usage requirement for CO₂ removal due to the relatively high temperatures to which the sorbents and solvents are heated. In many instances, the energy usage required for the removal of CO₂ via DAC using the TVS process is relatively high compared to other CO₂ removal techniques.

The relatively high energy usage requirement of the TVS process may be due to three primary reasons: 1) sorbent degradation is promoted at elevated temperatures; 2) high energy demand to generate requisite temperatures for regeneration; and 3) conductive heating in vacuum is relatively slow, which in turn may require an oversized system.

By way of particular example and for purposes of explanation, separating dilute gas species such as CO₂ that is present in the atmosphere in 400 ppm from the rest of the gases would require about 0.45 GJ per ton of CO₂ (GJ/tCO₂) at minimum based on thermodynamics. If using sorbents to separate CO₂ from air, the minimum energy may be represented with the enthalpy of desorption, which may typically be around 1.5 GJ/tCO₂ for amine-based sorbents. Compared to this, some DAC systems based on amine-based sorbents and TVS processes for desorption may typically require an order of magnitude more energy than the enthalpy of desorption of sorbents due to the inefficiencies associated with the TVS process. As a result, the levelized cost of these DAC systems based on amine-based sorbents and TVS may be close to, for instance, $500/tCO₂. Even with potential system improvements and optimization, their cost is not anticipated to be reduced below $102/tCO₂, which is the cost target set by the U.S. Department of Energy.

The apparatuses and systems disclosed herein may improve upon these issues by increasing the efficiency in desorbing CO₂ from sorbents, and thus reducing the cost and energy usage associated with using DAC for CO₂ removal. The apparatuses and systems disclosed herein may increase efficiency through use of electromagnetic-based sorbent regeneration of sorbents or solvents, which is an alternative to TVS to induce CO₂ desorption. The electromagnetic energy may be referred to herein as radio frequency (RF) or microwave (MW) energy. While the present disclosure refers to MW energy, it should be appreciated that energy in other frequency ranges are applicable and the present disclosure is not limited to MW energy.

Microwave-based DAC may require significantly less energy to operate than TVS-based DAC. Microwaves may decrease the overall energy needed to regenerate the sorbents because CO₂ desorption occurs at relatively lower temperatures than with TVS through selective heating near CO₂ binding sites. By facilitating selective heating at the CO₂-binding sites, CO₂ desorption near ambient temperature may be possible, which may significantly reduce the energy demand. Microwaves may also reduce the time for regeneration due to an accelerated heating rate when compared to TVS. In some instances, CO₂ desorption rates using microwaves for regeneration may be 4 to 17 times faster than conventional bulk heating methods for various types of sorbents.

However, the efficiency of microwave-based desorption may be directly related to the efficiency with which the microwave energy reaches the sorbents. In this regard, the structure of the sorbents, such as the shape and dimensions of the sorbent structure, as well as the design of the regenerators to evenly distribute the microwave energy may affect the efficiency of the DAC. By way of example, the sorbents commonly used in DAC systems are those that have simple panel shapes, with a flat surface. A flat surface may cause reflection of the microwave energy, which may decrease efficiency, and in turn increase the amount of energy required to perform the desorption. The efficiency may also degrade if the sorbent structure allows the microwave energy to dissipate unevenly into the sorbent structure. The efficiency may also degrade if the microwave energy is applied unevenly to the sorbent structure. For instance, uneven distribution of microwave energy incident upon the sorbent structure passing through a regeneration chamber may cause hotspots that decrease efficiency.

The apparatuses and systems as disclosed herein may also reduce the cost and energy usage of dilute material recovery, such as microwave-based DAC, through system downsizing enabled by a shortened regeneration time. The disclosed sorbent structure and the mechanism by which the sorbent structure may be cycled through the system for adsorption and desorption may improve efficiency of the microwave-based dilute material recovery, and thus further shorten the processing time. The disclosed apparatuses and systems may extend the lifespan of sorbents by minimizing thermal oxidation.

Disclosed herein are apparatuses and systems that may include a sorbent structure. The sorbent structure may include sorbent material formed to have a 3-dimensional shape including a plurality of protrusions. The sorbent material may adsorb a compound, such as CO₂, from ambient air that passes through the sorbent structure and may desorb the adsorbed compound in response to electromagnetic energy radiated at the sorbent material. The plurality of protrusions may distribute the electromagnetic energy into the sorbent structure to minimize reflection of the electromagnetic energy incident on the sorbent structure and may evenly dissipate the incident electromagnetic energy within the sorbent structure.

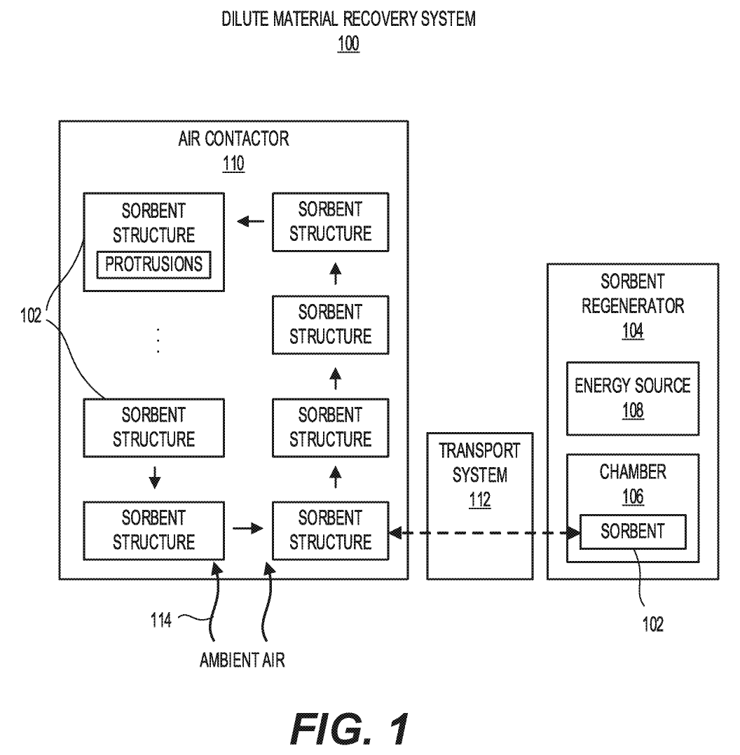

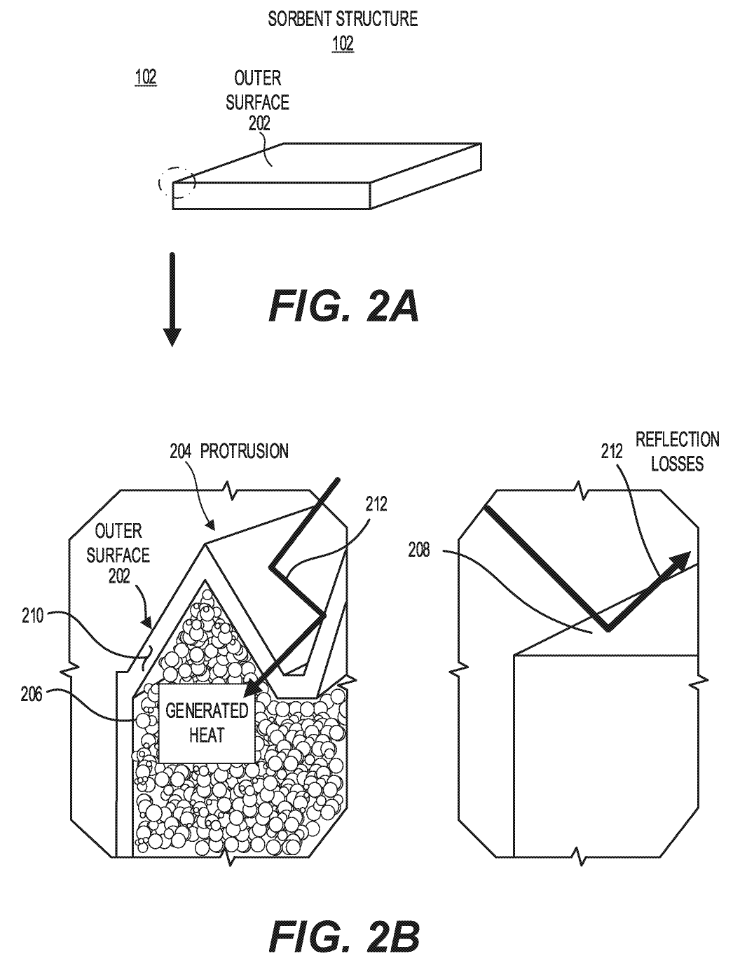

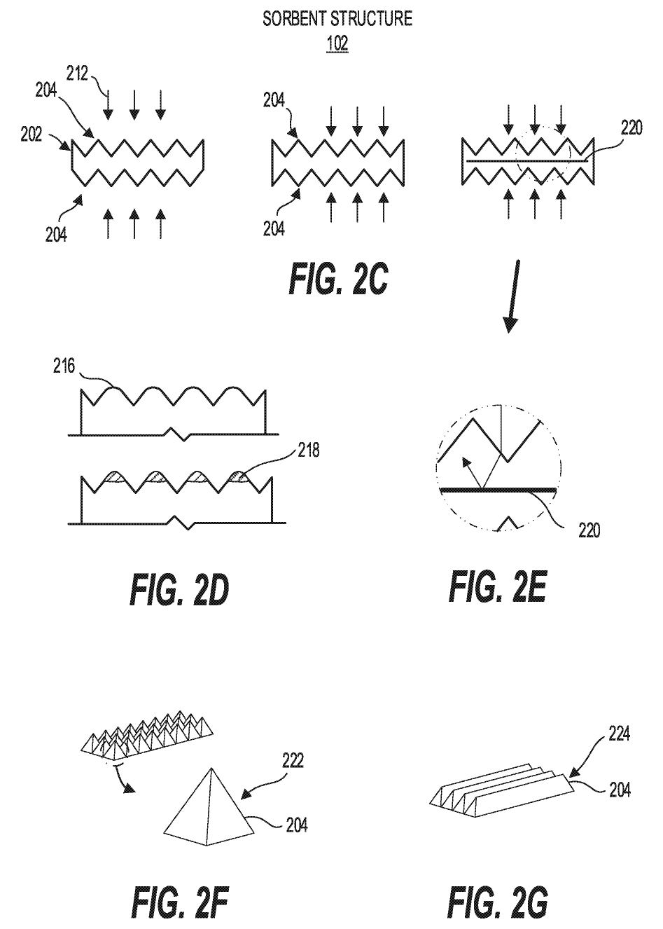

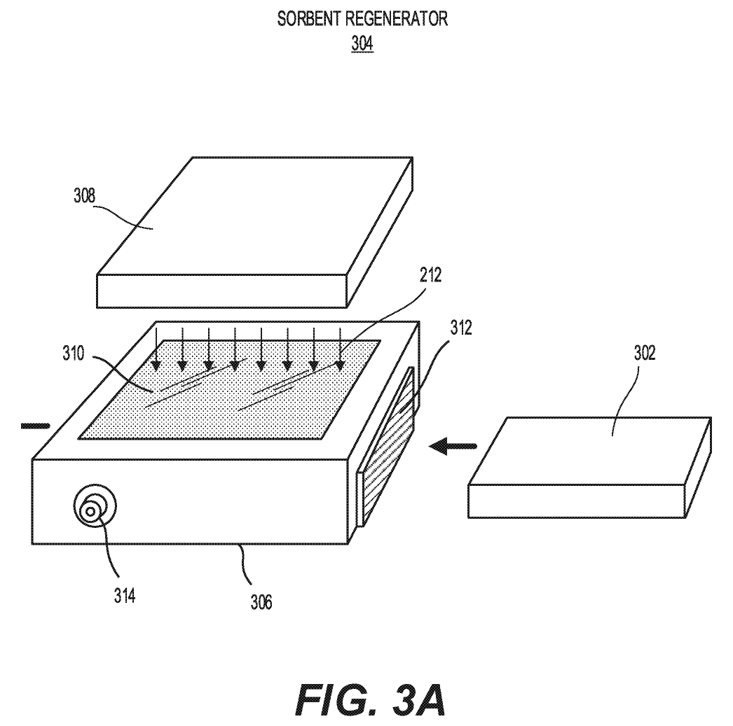

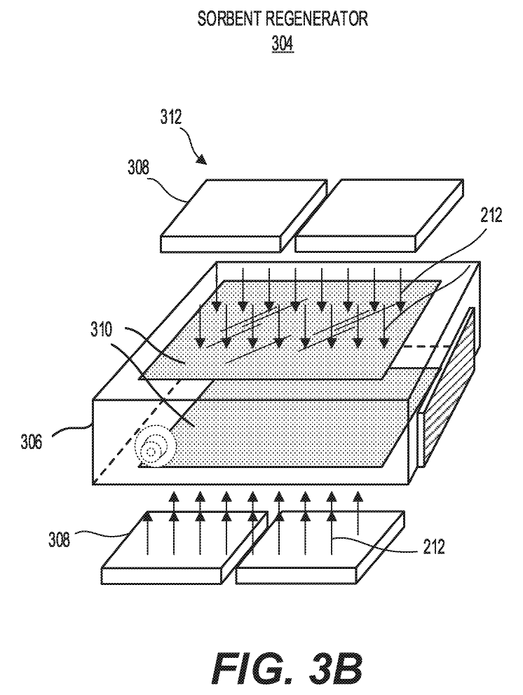

Reference is made to FIG. 1, FIGS. 2A TO 2G, and FIGS. 3A and 3B. FIG. 1 depicts a diagram of an example dilute material recovery system 100. FIG. 2A depicts a perspective diagram of an example apparatus 102 having a rectangular shape. FIG. 2B depicts a cross-sectional side view of the example apparatus 102 including a sorbent material 206 formed to have a plurality of protrusions 204. FIG. 2C depicts a cross-sectional side view of an example apparatus 102 including a plurality of protrusions 204 disposed on two sides of the apparatus 102. FIG. 2D depicts a cross-sectional side view of an example apparatus 102 including modified tips 216, 218 on the plurality of protrusions 204. FIG. 2E depicts a cross-sectional side view of an example apparatus 102 including a reflective layer 220. FIG. 2F depicts a 3-dimensional perspective view of an example apparatus 102 in which the plurality of protrusions 204 have a pyramid shape 222. FIG. 2G depicts a 3-dimensional perspective view of an example apparatus 102 in which the plurality of protrusions 204 have a triangular prism shape 224. FIG. 3A depicts a diagram of an example sorbent regenerator 104 to regenerate sorbent material 206 disposed in the sorbent structure 102. FIG. 3B depicts a diagram of an example energy source 108 that emits electromagnetic energy 212 at the sorbent structure 102. It should be understood that the example apparatus 102 may include additional features and that some of the features described herein may be removed and/or modified without departing from the scope of the dilute material recovery system 100.

As depicted in FIG. 1, the dilute material recovery system 100 may include an apparatus 102, which is also referred to herein as a sorbent structure 102, a sorbent regenerator 104, which may include an energy source 108, and an air contactor 110. The dilute material recovery system 100 may operate in batch-mode for sorbent regeneration, in which a plurality of sorbent structures 102 share the sorbent regenerator 104 to undergo regeneration in turn. For example, a plurality of sorbent structures 102 may be disposed in the air contactor 110 to adsorb dilute material, such as CO2, from ambient air 114 flowing through the air contactor 110. As each of the sorbent structures 102 becomes saturated, each of the sorbent structures 102 may be moved into the sorbent regenerator 104 for sorbent regeneration.

The dilute material recovery system 100 may include a transport system 112 that moves the sorbent structures 102 between the air contactor 110 and the sorbent regenerator 104. The sorbent structures 102 in the dilute material recovery system 100 may be mounted on the transport system 112. The transport system 112 may be a rail system, a conveyor belt system, a vacuum tube system, or the like. The transport system 112 is also referred to herein as a transport mechanism or conveyor mechanism. In some examples, the air contactor 110 may have a vertical configuration such that the sorbent structures 102 are arranged vertically inside the air contactor 110. The transport system 112 may move the sorbent structures 102 according to a periodic pattern through the air contactor 110 and may then individually move the sorbent structures 102 into the sorbent regenerator 104 for desorption. In some examples, the sorbent structures 102 may be moved in a loop through the air contactor 110 via the conveyor belt at a predetermined rate. The rate at which the transport system 112 moves the sorbent structures 102 through the air contactor 110 may be based on the rate of adsorption by the sorbent structures 102 in the air contactor 110 and the rate of regeneration of the sorbent material in the sorbent regenerator 104.

As depicted in FIGS. 2A and 2B, the sorbent structure 102 may include a sorbent material 206 to capture various types of diluted material, such as contaminants, volatile organic compounds (VOC), water, or the like, from mixed gas streams including ambient air, flue gas or the like. As depicted in FIG. 2A, the sorbent structure 102 may have a rectangular shape, a panel shape, a cuboid, and/or the like. The sorbent structure 102 may be formed to have a plurality of protrusions 204, for instance, on an outer surface 202 of the rectangular shape. The sorbent material 206 may include a variety of form factors for the sorbents including loosely packed sorbent beads or pellets, coated fibers, structured monoliths, liquid solvent, foams or gels, films and coatings, or the like. The sorbent material 206 may be selected based on its characteristics, particularly with respect to the compounds or contaminants to be extracted. For example, in the case of CO₂, zeolite beads may be used for its relatively high CO₂ selectivity and microwave absorption. The sorbent material 206 adsorbs CO₂ from ambient air that passes through the sorbent structure 102 and desorbs the CO₂ in response to the microwave energy 212 to regenerate the sorbent material 206.

As depicted in FIG. 2B, the sorbent structure 102 may include a plurality protrusions 204. The protrusions 204 may improve micro energy reflection of microwaves at the outer surface 202 of the sorbent structure 102 as well as promote uniform dissipation of the microwave energy across the bulk material.

As the microwave energy 212 reaches the outer surface 202, the angled face of the protrusions 204 may reduce reflection of the microwaves and may more uniformly or evenly distribute the microwave energy 212 inside the sorbent structure 102. In contrast, in a case of a flat outer surface 208, the microwave energy 212 may reflect off the surface resulting in losses, which may result in reduced efficiency of the system. The flat outer surface 208 may also result in uneven distribution of energy across the volume of the sorbent material 206, which may cause hotspots within the bulk material.

The protrusions 204 may be designed to have a predetermined shape and dimensions based on the properties of the sorbent material 206, such as dielectric loss and density of the sorbent material 206. The geometry of the protrusions 204 may be tailored to the particular type of sorbent material 206 being used. The predetermined shape of the protrusions 204 may include the angle of the side surfaces, the length or size of the side surfaces, and the spacing or the period between the protrusions 204. The predetermined dimensions and the arrangement pattern of the protrusions 204 may be user-defined, based on historical data, experimentation, testing, modeling, and/or the like. In some examples, finite element simulations may be conducted to determine the optimal geometry of the protrusions 204.

In some examples, the sorbent structure 102 may include a casing 210 and the sorbent material 206 may be disposed inside the casing 210. The casing 210 may be fabricated using a synthetic polymer such as polytetrafluoroethylene (PTFE). The casing 210 may be fabricated with the protrusions 204 having the predetermined dimensions and arrangement patterns such that when the sorbent material 206 is placed inside the casing 210, the sorbent material 206 conforms to the shape of the casing 210. In this instance, the outer surface 202 may be a surface on the casing 210. In some examples, the sorbent material 206 may be in the form of beads, pellets, coated fibers, structured monolith, liquid solvent, powder, foams or aerogels, 3-D printed geometries, or the like, which may be filled inside the casing 210.

In some examples, the sorbent structure 102 may be fabricated using a support substrate. The support substrate may be a made of ceramic. In some examples, the support substrate may be a monolith. The protrusions 204 may be formed on the support substrate to have predetermined dimensions and arrangement. In some examples, the support substrate may be cut to have the desired shape of the protrusions 204. The sorbent material 206 may be applied to the support substrate, for instance, coated or painted on the support substrate to form the sorbent structure 102. The sorbent material 206 may also be incorporated into the support substrate. That is, the support substrate, and hence, the casing 210, may be made with sorbents. For instance, sorbents may be mixed with binders, which then may be used to fabricate the sorbent structure 102 in various ways, such as monoliths, laminated structure, or 3-D printed. In some examples, the casing 210 may be coated or painted with films, coatings, foams, and aerogels made with the mixture of sorbent and binder. In these instances, the outer surface 202 may be a surface on the sorbent material 206.

In some examples, and as depicted in FIG. 2C, the microwave energy 212 may be applied on multiple sides of the sorbent structure 102 in order to more uniformly distribute the microwave energy 212. In some examples, a reflector layer 220 may be disposed between the two outer surfaces to improve energy dissipation. The reflector layer 220 may be formed of reflective materials, such as aluminum (Al), or the like, such that microwave energy 212 that reaches the reflector layer 220 may be reflected back through the sorbent structure 102.

In some examples, and as depicted in FIG. 2D, the tips 216, 218 of the protrusions 204 may be modified to improve uniformity of energy dissipation. In general, energy dissipation may tend to be non-uniform across a particular volume of sorbent material 206, such as within a particular protrusion 204. For instance, the intensity of heat at the center of the volume of a protrusion may be greater than at other regions. To improve energy dissipation across the volume of material, the protrusions 204 may have a rounded tip 216, which may redistribute the material toward the center of the protrusion 204. In some examples, the tips 218 of the protrusions 204 may be formed of a different material that has different dielectric properties. As depicted in FIG. 2E, a reflector layer 220 may be disposed under the sorbent structure 102. The reflector layer 220 may be formed of reflective materials, such as Al, or the like.

In some examples, and as depicted in FIG. 2F, the protrusions 204 may have a pyramid shape 222. A side surface of the pyramid shape 222 may have a predetermined angle and a predetermined length based on the type of the sorbent material 206. The pyramid shaped protrusions 204 may be arranged in a grid pattern on the outer surface, having a predetermined period between the points of the protrusions 204.

In some examples, and as depicted in FIG. 2G, the protrusions 204 may have a triangular prism shape 224. Each of the plurality of protrusions 204 may be arranged parallel to each other along a lateral face of the triangular prism shape 224.

In some examples, an impedance matching layer (not shown) may be disposed between the energy source 108 and the sorbent structure 102 to improve efficiencies related to reflection of microwave energy in the sorbent structure 102. In this example, a horn antenna may be used to emit microwaves. The impedance matching layer may be disposed inside the housing of the horn antenna, between the energy source 108 and the sorbent structure 102, to reduce unwanted micro energy reflection.

During the adsorption processes, the sorbent material 206 adsorbs dilute material, such as CO₂, as ambient air comes into contact with the sorbent material 206. The rate of movement of the sorbent structure 102 through the air contactor 110 may be based on the rate of adsorption of the sorbent material 206. The rate of adsorption may be dependent on the type of sorbent material 206. For instance, the air contactor 110 and the transport system 112 may be calibrated such that the sorbent material 206 may be completely saturated with CO₂ as the sorbent structure reaches a predetermined point in the air contactor 110. In some examples, a fan may be provided to increase airflow through the air contactor 110, which may improve adsorption by the sorbent material 206.

Once the adsorption is complete, the sorbent structure 102 may be transported to the sorbent regenerator 104 via the transport system 112. As depicted in FIG. 1, the sorbent regenerator 104 may include a chamber 106. The chamber 106 may be a vacuum-compatible chamber and may include vacuum sealable doors and a vacuum/compressor port. The vacuum chamber 106 may typically operate between 10-200 mbar, but may operate at pressures as low as 0.1 mbar if necessary.

FIG. 3A depicts an example sorbent regenerator 304 including an energy source 308 to emit electromagnetic energy 212, such as microwave energy, at a sorbent structure 302 to regenerate a sorbent material. The sorbent structure 302, the sorbent regenerator 304, and the energy source 308 may be the same as the sorbent structure 102, the sorbent regenerator 104, and the energy source depicted in FIG. 1. The energy source 308 may generate microwave energy, but it should be understood that electromagnetic energy 212 at other frequencies are possible. The energy source 308 and electromagnetic energy 212 are also referred to herein as a microwave energy source 308 and microwave energy 212, respectively. For CO₂ capture, the energy source 308 may emit microwave energy 212 to the sorbent structure 302 to cause the sorbent material 206 to desorb CO_{2.} The energy source 308 may have a shape that correlates to the size of the vacuum chamber, for instance a rectangular plate shape, such that it may generate a relatively uniform electric field across the entire surface of the sorbent structure 302.

The sorbent regenerator 304 may have a vacuum chamber 306, which may be similar to the vacuum chamber 106. A microwave-transparent window 310 may be disposed on a surface of the vacuum chamber 306 to allow the emitted microwave energy 212 to enter the vacuum chamber 306. The microwave-transparent window 310 may be made of various types of materials such as glass, PTFE, plastics, and/or the like, which are compatible with vacuum pressures. The sorbent regenerator 304 may include a vacuum compatible door 312 through which the sorbent material 302 may be placed inside the vacuum chamber 306. In some examples, a second vacuum compatible door 312 may be installed, which may be the exit door. The transport system 112 may feed the sorbent structure 302 through the vacuum chamber 306 at a predetermined feed rate. The regeneration process may result in a purified stream of CO₂, which may be captured by a vacuum pump (not shown). In this regard, a vacuum/compressor port 314 may be installed on the vacuum chamber 306 to allow connection to the vacuum pump.

As depicted in FIG. 3B, the energy source 308 may include a single source or an array of sources 312. The energy source 308 may have various types of antennas, such as a slotted antenna, a horn antenna, a phase array antenna, and/or the like. In some examples, multiple energy sources 308 may be disposed to emit electromagnetic energy 212 at different sides of the sorbent structure 302, for example, at both the top and the bottom of the sorbent structure 102. In this instance, a second microwave-transparent window 310 may be installed on the bottom side of the vacuum chamber 306.

As previously described with reference to FIG. 1, the air contactor 110 and the sorbent regenerator 104 included in the dilute material recovery system 100 may be connected in a loop via the transport system 112, such that each sorbent structure 102 may be continuously transported from an adsorption process to a desorption process. The plurality of sorbent structures 102 in the dilute material recovery system 100 may be mounted on the transport system 412 via a conveyor belt, rails, or the like. The air contactor 110 may have a vertical configuration such that the sorbent structure 102 enters the air contactor 110 through a door at the bottom of the air contactor 110, and travels up and down the length of the air contactor 408 in a loop, while adsorbing CO₂ from the ambient air. In some examples, the air contactor 110 may include a fan to force ambient air through the air contactor 110 to improve adsorption.

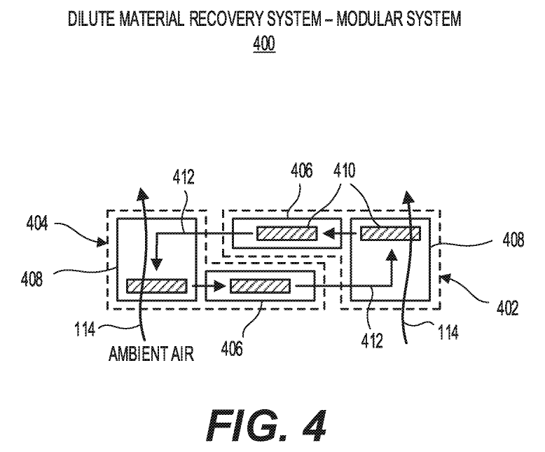

Reference is made to FIG. 4. FIG. 4 depicts a block diagram of an example dilute material recovery system 400 that continuously circulates a plurality of sorbent structures 410 for regeneration. It should be understood that the example dilute material recovery system 400, the example sorbent regenerator 406, the example air contactor 408, and the example sorbent structure 410 may include additional features and that some of the features described herein may be removed and/or modified without departing from the scope of the dilute material recovery system 400, the sorbent regenerator 406, the air contactor 408, and the sorbent structure 410.

As depicted in FIG. 4, the dilute material recovery system 400 may include a plurality of modules 402, 404 that are connected to each other. The number of modules 402, 404 may be increased based on the number of sorbent structures 410 needed, which may increase the capacity of the dilute material recovery system 400. The sorbent structures 410 may be the same as the sorbent structures 102 as depicted in FIG. 2A to 2G. The module 402 may include an air contactor 408 and a sorbent regenerator 406. The module 404 may be configured in the same manner, to include an air contactor 408 and a sorbent regenerator 406. The air contactor 408 may be the same as the air contactor 110, as depicted in FIG. 1, and the sorbent regenerator 406 may be the same as the sorbent regenerator 104 depicted in FIG. 1. The air contactors 408 and the sorbent regenerators 406 included in the dilute material recovery system 400 may be connected in a loop, such that each sorbent structure 410 may be continuously transported from an adsorption process to a desorption process. The sorbent structure 410 may include a sorbent material 206 and an outer surface 202. The outer surface 202 may be a surface on a casing that holds the sorbent material 206 or, in the case where the sorbent material 206 is coated on a substrate, the outer surface 202 may be a surface on the sorbent material 206.

In some examples, the plurality of sorbent structures 410 in the dilute material recovery system 400 may be mounted on a transport system 412. The transport system 412 may be a rail system, a conveyor belt system, or the like. The air contactor 408 may have a vertical configuration such that the sorbent structure 410 enters the air contactor 408 through a door at the bottom of the air contactor 408 in module 402, travels up the length of the air contactor 408 while adsorbing CO₂ from the ambient air, and exits through a door at the top of the air contactor 408 at the end of the regeneration process. In some examples, the air contactor 408 may include a fan to push ambient air through the air contactor 408 to improve adsorption.

During the adsorption processes, the sorbent material 206 may adsorb dilute material, such as CO₂, as ambient air comes into contact with the sorbent material 206. The rate of movement of the sorbent structure 410 through the air contactor 408 may be based on the rate of adsorption of the sorbent material 206. The rate of adsorption may be dependent on the type of sorbent material 206. For instance, the air contactor 408 may be calibrated such that the sorbent material 206 may be completely saturated with CO₂ as the sorbent structure 410 reaches the top of the air contactor 408 in module 402.

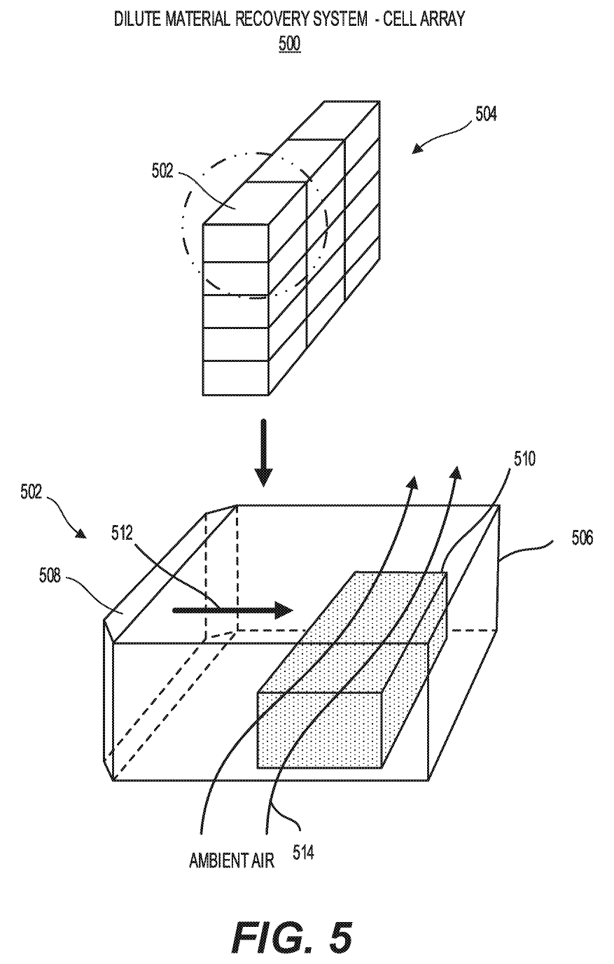

Reference is made to FIG. 5. FIG. 5 depicts a block diagram of an example dilute material recovery system 500 that includes an array of cells. It should be understood that the example dilute material recovery system 500 may include additional features and that some of the features described herein may be removed and/or modified without departing from the scope of the dilute material recovery system 500.

The dilute material recovery system 500 may include a plurality of cells 502, arranged in an array of cells 504. The dilute material recovery system 500 may operate in batch-mode for sorbent regeneration, in which a sorbent structure 510 is used for dilute material capture. The sorbent structure 510 may be the same as the sorbent structure 102 depicted in FIGS. 2A to 2G. In some examples, the dilute material recovery system 500 may be a DAC system that captures CO₂ from ambient air using solid sorbent material 206.

Each cell 502 may include a chamber 506, which may be vacuum compatible, and a dedicated energy source 508. The energy source 508 may be a microwave source. The sorbent structure 510 may be fixed inside the chamber 506 such that the chamber 506 operates as both an air contactor and a sorbent regeneration chamber. The chamber 506 may allow ambient air 514 to flow through the sorbent structure 510 for dilute material adsorption. In some examples, the chamber 506 may include a fan for increased air flow through the chamber 506 to improve adsorption by the sorbent structure 510.

A plurality of cells 502 may be arranged in the array of cells 504. The sorbent structure 510 in each of the cells 502 may be regenerated individually via the dedicated energy source 508 in each cell 502. In this case, each sorbent structure 510 may be regenerated based on whether the sorbent structure 510 has reached saturation. In some examples, a single energy source 508 may be provided to emit energy to the entire array of cells 504. In this case, each cell 502 may include a transparent window to allow the emitted energy to reach the sorbent structure 510.

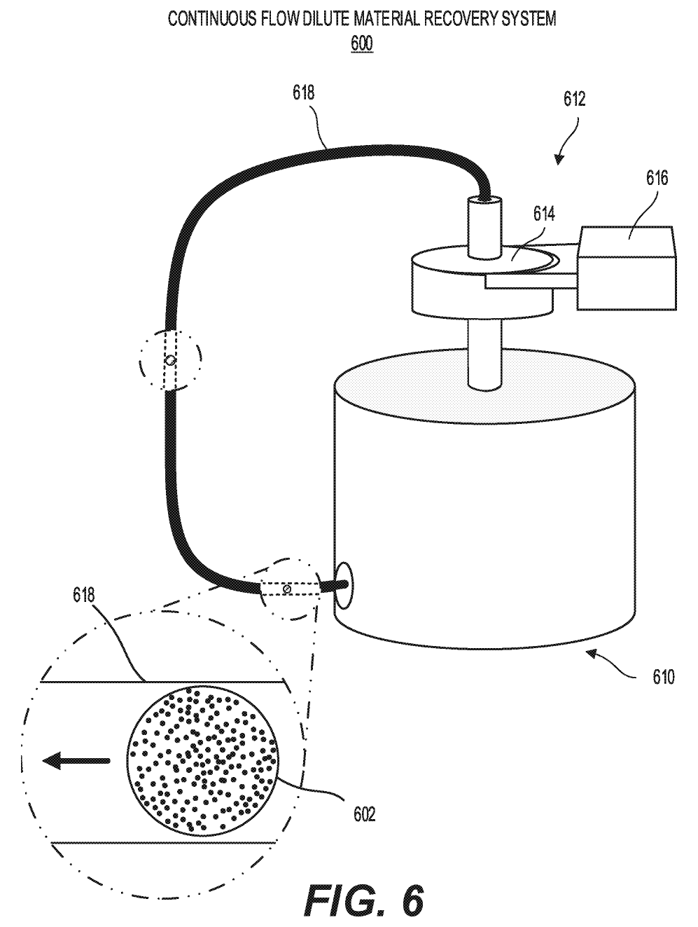

Reference is made to FIG. 6. FIG. 6 depicts a diagram of an example continuous flow dilute material recovery system 600 that includes a tube 618 that connects an air contactor 610 and a sorbent regeneration chamber 614, and a sorbent structure 602 having a round shape to move through the tube 618. It should be understood that the example continuous flow dilute material recovery system 600 may include additional features and that some of the features described herein may be removed and/or modified without departing from the scope of the continuous flow dilute material recovery system 600.

As depicted in FIG. 6, the continuous flow dilute material recovery system 600 may include an air contactor 610 and a sorbent regenerator 612 for processing sorbents 602. The sorbents 602 may be solid sorbents or liquid solvents in which CO₂-capturing moieties may be dissolved or suspended in aqueous or non-aqueous solutions. The sorbent regenerator 612 may include a sorbent regeneration chamber 614 and an energy source 616 disposed to emit electromagnetic energy at the sorbents 602 as it passes through the sorbent regeneration chamber 614. The energy source 616 may be a MW energy source. The regeneration chamber 614 may be a resonant cavity for RF/MW energy.

The continuous flow dilute material recovery system 600 may include a tube 618 connected between the air contactor 610 and the sorbent regenerator 612 to transport the sorbents 602 between the air contactor 610 and the sorbent regenerator 612. The tube 618 may be referred to herein as a feedline, a channel, a pipe, or a transport mechanism. The tube 618 may have a predetermined cross-section based on the sorbent used. For example, for solid sorbents in which the sorbent structure has a round shape, such as a spherical shape or a cylindrical shape, the cross-section of the tube 618 may have a round shape to accommodate the sorbent structure. The sorbents 602 may be disposed inside the tube 618 to continuously circulate between the air contactor 610 and the sorbent regenerator 612.

The continuous flow dilute material recovery system 600 may employ various mechanisms to circulate the sorbents 602 within the system such as vacuum pressure, gravitational feed, or another appropriate type of transport mechanism as described in the present application. For instance, the tube 618 may be under vacuum to circulate the sorbents 602 using vacuum pressure. In some examples, as depicted in FIG. 6, the tube 618 may run vertically or at an incline through the sorbent regenerator 612 and the air contactor 610 for gravitational feed of the sorbents 602.

In some examples, the sorbents 602 may be solid sorbents or sorbent structures suspended in non-aqueous solutions for transport in the tube 618. The air contactor 610 may be based on a cross-flow gas-filled contactor filled with packing materials. In some examples, a pump may be disposed in the continuous flow dilute material recovery system 600 to enable flow through the tube 618.

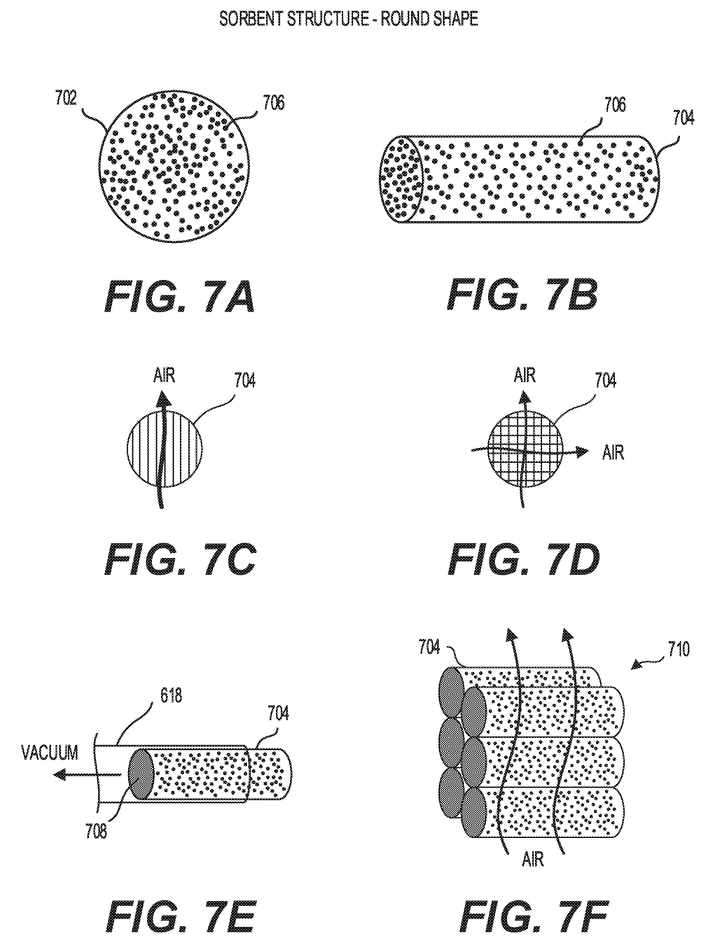

Reference is made to FIGS. 7A to 7G. FIG. 7A depicts a side view of an example sorbent structure 702 having sorbent material shaped in a spherical shape. FIG. 7B depicts a 3-dimensional perspective view of an example sorbent structure 704 having sorbent material shaped in a cylindrical shape. FIG. 7C depicts a cross-sectional view of a sorbent structure 704 that allows airflow in one direction or axis. FIG. 7D depicts a cross-sectional view of a sorbent structure 704 that allows airflow in multiple directions. FIG. 7E depicts a partial 3-dimensional perspective view of a sorbent structure 704 having a capped end 708 that maintains pressure in a tube 618 under vacuum. FIG. 7F depicts a 3-dimensional perspective view of a stacked group 710 of a plurality of sorbent structures 704. It should be understood that the example sorbent structures 702, 704 may include additional features and that some of the features described herein may be removed and/or modified without departing from the scope of the sorbent structures 702, 704.

FIG. 7A depicts a sorbent structure 702 having a spherical shape and FIG. 7B depicts a sorbent structure 704 having a cylindrical shape. The sorbent structure 702, 704 may be used as the sorbents 602 in the continuous flow dilute material recovery system 600 depicted in FIG. 6.

The sorbent structure 702, 704 may be formed of a porous sorbent material 706 that allows gasses to pass through the sorbent structure 702, 704. The sorbent structure 702, 704 may be fabricated: 1) entirely out of sorbents, 2) sorbents mixed with a binder, and 3) sorbents coated, appended, or grafted on a substrate. For instance, the sorbent structure 702, 704 may be made out of sorbents without a permanent binder, and molded to the desired shape. The sorbent structure 702, 704 may also be fabricated using a mixture of sorbent and binder, which may provide added strength to form the desired structure and shape. For instance, foams and aerogels may be used to form a highly porous, sponge-like structures where the binder helps maintain a ridged, open-cell network that CO2 can easily penetrate. Binders may also be used to create thin films or coatings that may be painted or deposited on a substrate.

In some examples, the sorbent structure 702, 704 may have a sponge-like consistency. The sorbent material 706 may be shaped into various shapes, such as a sphere or a cylinder. The size of the sorbent structures 702, 704 may be in the range of millimeters to tens of centimeters. The spherical sorbent structure 702 and the cylindrical sorbent structure 704 may have similar cross-sectional shapes and dimensions, in which case they may be compatible with the same tube 618. It should be appreciated that the sorbent structure 702, 704 as described in the present disclosure is not limited to a spherical shape and a cylindrical shape, and may have various shapes. In some examples, the sorbent structure 702, 704 may have an oval shape, an elliptical shape, a rectangular shape, or another appropriate shape based on the intended implementation of the system, the type of sorbent material 706 used, and the configuration of the dilute material recovery system.

As depicted in FIGS. 7C and 7D, the sorbent structure 704, or 702, may allow for directional control of the airflow through the sorbent structure 704. For instance, the sorbent structure 704 may be formed such that air may flow in one direction or along one axis, as depicted in FIG. 7C. The sorbent structure 704 may be made using non-monolithic channeled substrates, such as laminates or corrugated packing that have multiple sheets stacked together that form channels in a desired direction. Alternatively, the sorbent structure may be formed such that air may flow in multiple directions, as depicted in FIG. 7D, for instance, by using functionalized fibrous materials, such as woven or unwoven glass fiber, foams, or the like, that allow gas dissipation in multiple directions. The sorbent structure 704 may allow directional permeability through pore alignment in a predetermined direction, channels formed through the sorbent structure 704, placement of membranes aligned within the sorbent structure 704, by sealing or plugging the pores on sections of the outer surface of the sorbent structure 704, and/or the like.

As depicted in FIG. 7E, the sorbent structure 704 may have a capped end 708 that creates a vacuum seal inside the tube 618. The end 708 of the sorbent structure 604 may be formed of a non-porous material that creates a vacuum seal inside the tube 618 as the sorbent structure 604 is fed into the tube 618. In some examples, the end 708 may be a cap or cover attached to one or both distal ends of the sorbent structure 704.

As depicted in FIG. 7F, a plurality of sorbent structures 704 may be stacked together to form a stacked array or group 710. The stacked array 710 of sorbent structures 704 may allow gases to flow through each of the sorbent structures 704. In some examples, a transport mechanism may transport the sorbent structures 704 into a chamber of an air contactor, such as the air contactor 110 or 610. The transport mechanism may position each sorbent structure 704 adjacent to each other to form the stacked group 710. The stacked group 710 of sorbent structures 704 may adsorb CO₂ as the air flows through the air contactor.

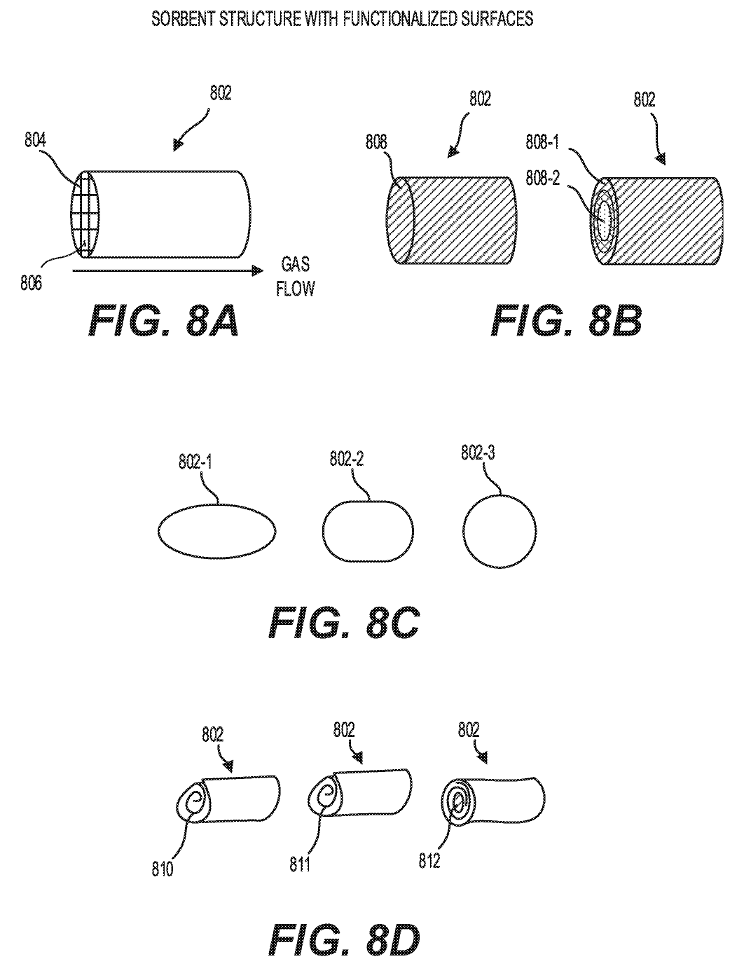

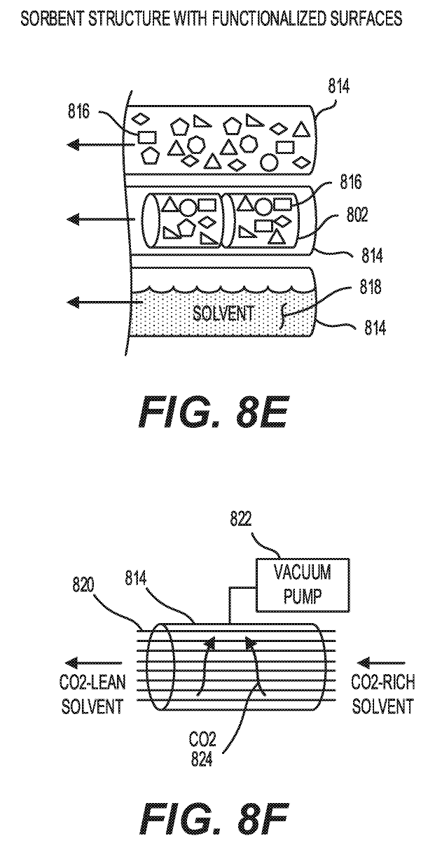

Reference is made to FIGS. 8A to 8F. FIG. 8A depicts a 3-dimensional perspective view of a sorbent structure 802 having a monolith support structure 804. FIG. 8B depicts a 3-dimensional perspective view of a sorbent structure 802 having functionalized fibers 806 with variable fiber density. FIG. 8C depicts a side view of sorbent structures 802-1, 802-2, 802-3 having various shapes. FIG. 8D depicts a 3-dimensional perspective view of a sorbent structure 802 having a spiral-wound membrane 808 or mesh 810. FIG. 8E depicts a cross-sectional view of sorbent material 816 and sorbent structures 802 in a passage of a tube 814. FIG. 8F depicts a 3-dimensional perspective view of a tube 814 at a regeneration chamber, such as the sorbent regeneration chamber 614, having an array of membranes 818 that allows a flow of solvent. It should be understood that the example sorbent structures 802 and the tube 814 with membranes 818 may include additional features and that some of the features described herein may be removed and/or modified without departing from the scope of the sorbent structures 802 and the tube 814 with membranes 818.

For efficient processing with RF/MW energy, materials being processed may be “shaped.” Sorbent materials may come in a variety of forms and different types of support structures may be used to shape a sorbent structure. For instance, the shape of a liquid solvent may be defined by the geometry of a passage through which it flows. The passage may be in various forms, such as a pipe, tube, a feedline, a channel, a slit, or the like. A solid sorbent’s shape may also be defined by the geometry of the passage. For instance, when the sorbents are in bead or pellet form, the shape of the sorbents may conform to the shape of the passage through which it moves. In some examples, the sorbents may be fabricated with predefined forms, such as cylindrical, spherical, or panel shapes.

As depicted in FIG. 8A, the sorbent structure 802 may have a cylindrical shape. The sorbent structure 802 may be implemented as the sorbents 602 in the continuous flow dilute material recovery system 600 depicted in FIG. 6. The sorbent structure 802 may have a monolith support 804 that provides structural support. The sorbent structure 802 may be made of glass, a ceramic material, a gas permeable material, a functional fiber, or the like. The monolith support 804 may be fabricated by various methods, including molds, 3-dimensional printing, or the like.

The monolith support 804 may have a plurality of passages 806. The plurality of passages 806 may be micro channels, for instance for airflow, and the number and size of the plurality of passages 806 may be determined based on the type of sorbent material used and the intended application, such as for CO2 or H₂O. The plurality of passages 806 may extend across the length of the monolith support 804 to allow airflow through the sorbent structure 802. In some examples, the monolith support 804 may be fabricated using a gas permeable material to allow airflow in a radial direction.

The monolith support 804 may have functionalized surfaces in which the surfaces of the monolith support 804 chemically bind with dilute material, such as CO₂ molecules in air. In some examples, the surfaces of the monolith support 804 may be functionalized by coating or grafting the surfaces with sorbent material, chemically modifying the surface to have a covalent bond, or the like. In some examples, the monolith support 804 may be fabricated using functionalized materials, such as CO₂ capturing fibers.

As depicted in FIG. 8B, the sorbent structure 802 may be fabricated using functionalized fibers 808. In some examples, the functionalized fibers 808 may be treated to chemically bind with CO₂ molecules upon contacting air. For instance, the functionalized fibers 808 may be coated with CO₂-capturing moieties, or the like. The functionalized fibers 808 may have a predetermined density, which may be constant throughout the sorbent structure. In some examples, the fiber density along a radial direction of the sorbent structure 802 may be tunable. For instance, a density of the functional fibers 808-2 at the center of the sorbent structure 802 may be less than a density of the functional fibers 808-1 at the outer surface of the sorbent structure 802. In some examples, the sorbent structure 802 may have a donut-like shape, in which the center of the sorbent structure 802 is hollow or fabricated with microwave-transparent materials, which may reduce formation of hot spots at the center of the sorbent structure 802. The sorbent structure 802 made of functionalized fibers 808 may be formed of gas permeable material to allow gases to flow in a radial direction or an axial direction.

As depicted in FIG. 8C, the sorbent structure 802 may have various type of shapes. The sorbent structure 802-1 may have an oval or pod shape. The sorbent structure 802-2 may have an elliptical or pill shape. The sorbent structure 802-3 may have a spherical shape. However, it should be appreciated that the sorbent structure 802 is not limited to these shapes, and other shapes are within the scope of the present description. The sorbent structure 802-1, 802-2, 802-3 may be fabricated in the same manner as sorbent structure 802 as previously described with respect to FIG. 8A.

As depicted in FIG. 8D, the sorbent structure 802 may be fabricated by winding various types of materials. The sorbent structure 802 may be formed by winding a sheet of membrane 810 or a mesh 811. The membrane 810 or mesh 811 may be functionalized by modifying the surface to capture a desired compound, such as CO₂. The membrane 810 or mesh 811 may provide structural support for sorbent material. By way of particular example, the membrane or mesh 811 may be coated with moieties that chemically bind to a specific compound, such as CO₂, while repelling other substances, such as Nitrogen (N₂). In some examples, the membrane 810 may act as a physical filter. For instance, the membrane 810 may have tiny pores of a predetermined size. The membrane 810 may physically filter certain substances based on the size of pores, which may allow a desired molecule to pass while blocking other larger molecules. The membrane 810 or mesh 811 may also be functionalized to capture a desired substance by applying various types of sorbent materials.

In some examples, the sorbent structure 802 may be fabricated such that a center of the spiral-wound structure is electromagnetic energy transparent. For instance, an electromagnetic energy transparent material 812 may be disposed at the center of the spiral-wound structure. Alternatively, the spiral-wound structure may be fabricated to have a hollow center. The electromagnetic energy transparent material 812 or the hollow center may minimize formation of hot spots at the center of the sorbent structure 802.

As depicted in FIG. 8E, sorbent material may be “shaped” in different ways. In some examples, the sorbent material may be in the form of pellets 816, beads, or powder. In this instance, the pellets 816 may be placed inside the tube 814, or feedline, such that the shape of the tube 814 provides the structural support for the pellets 816.

In some examples, the sorbent structure 802 may be formed as a casing, and the sorbent material, such as the pellets 816, may be disposed inside the sorbent structure 802. The sorbent structure 802 may be made of a gas permeable material such that desorbed gases may pass through the surface of the casing during regeneration. It should be appreciated that while FIG. 8E depicts pellets 816 being stored in the sorbent structure, sorbent material in other physical forms may be stored in the sorbent structure 802, such as beads, powder, liquid solvent, or the like.

In some examples, the sorbent material may be in the physical form of a liquid solvent 818 and disposed inside the tube 814. In this instance, the tube 814 provides the structural support for the liquid solvent 818. By way of particular example and for purposes of description, the liquid solvent 818 may include CO₂-capturing moieties, which are dissolved or suspended in the aqueous or non-aqueous solutions to chemically bind with CO₂ molecules. The liquid solvent 818 may be used in any regeneration system as disclosed herein that is capable of handling solvents, such as the continuous flow dilute material recovery system 600 depicted in FIG. 6.

As depicted in FIG. 8F, an array of membranes 820 may be disposed inside the tube 814. The membranes 820 may extend parallel to each other, in a direction along a length of the tube 814. The membranes 820 may form a plurality of channels for liquid solvent, such as solvent 818, to flow inside the tube 814. The membranes 820 may be functionalized for capturing specific compounds, such as CO₂, as the liquid solvent 818 flows through the tube 814. In some examples, the membranes 820 may be coated with sorbent materials, such as CO₂-capturing moieties, to capture CO₂ as it comes into contact with CO₂-rich liquid solvent 818 flowing through the channels. The membranes 820 may allow the liquid solvent 818 to pass through the channels, while allowing desorbed gas 824 to diffuse out into the vacuum 822 for collection. In some examples, the membranes 820 may be positioned inside a regeneration chamber, such as the regenerator chamber 614. The tube 814 may be fabricated with gas permeable material at the inlet (not shown) for vacuum 822. In some examples, an opening (not shown) may be disposed on the tube 814 to allow the desorbed gas to escape into the vacuum 822 for collection. In some examples, a membrane may be disposed at the vacuum inlet to cover the opening to prevent the liquid solvent 818 from escaping. In some examples, a headspace may exist inside the tube 814. The vacuum inlet may be disposed at the headspace to prevent liquid solvent 818 leakage. In some examples, the upper most membrane 820 adjacent to the vacuum inlet may block the flow of the liquid solvent 818 to prevent leakage.

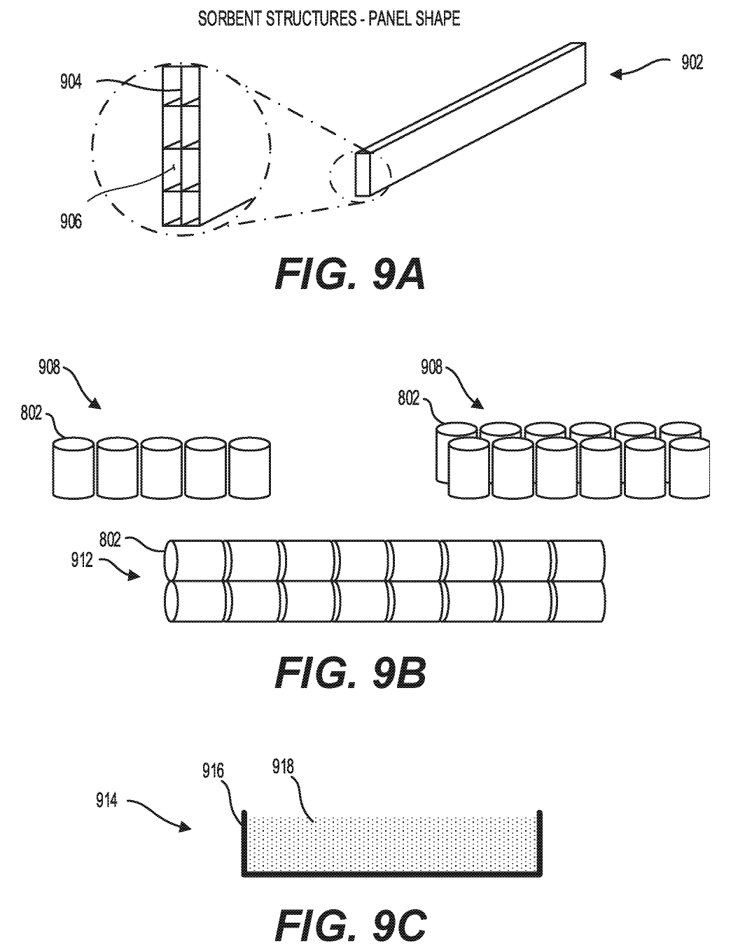

Reference is made to FIGS. 9A to 9C. FIG. 9A depicts a 3-dimensional perspective view of a panel shaped sorbent structure 902. FIG. 9B depicts a 3-dimensional perspective view of example panel shaped sorbent structures 904, 906, 908 including a plurality of cylindrical shaped sorbent structures 802. FIG. 9C depicts a cross-sectional side view of an example panel shaped sorbent structure 910 formed using a tray 912. It should be understood that the example panel shaped sorbent structures 902, 904, 906, 908, and 910 may include additional features and that some of the features described herein may be removed and/or modified without departing from the scope of the panel shaped sorbent structures 902, 904, 906, 908, and 910.

FIG. 9A depicts a sorbent structure 902 having a panel shape. The panel shape may be a flat, structured unit of material. A panel may also be referred to as a sheet, a plate, a pad, a mat, a structured adsorbent bed (SAB), or a pane. The panel shaped sorbent structure 902 may have a rectangular shape. It should be understood that the panel shaped sorbent structure 902 may have other shapes, such as an oval shape, a round shape, square shape, or the like, based on the desired implementation, the type of compound to be captured, the size of the regeneration chamber, the transport mechanism, and/or the like.

The panel shaped sorbent structure 902 may be fabricated using sheets of a substrate material, such as the membrane 810 as previously described with respect to FIG. 8D. A plurality of sheets of the membrane 810 may be cut to a predetermined width and height for the panel. The cut sheets may be formed into laminated stacks of a predetermined thickness to form the panel shape. In some examples, the panel shaped sorbent structure 902 may be fabricated using other types of substrate material, such as a mesh, a woven fiber, an unwoven fiber, and/or the like, which may be cut and stacked. The substrate material may be functionalized to adsorb a predetermined compound, such as CO₂. By way of particular example, the membrane 810 may be covered with a sorbent material, such as CO₂-capturing moieties, to capture CO₂ as it comes into contact with CO₂-rich air. Other types of functionalization is possible as previously described, for example, with respect to the sorbent structure 102 depicted in FIG. 2A and the sorbent structure 802 depicted in FIG. 802A.

The panel shaped sorbent structure 902 may be fabricated using a monolith 904, such as the monolith support 804 depicted in FIG. 8A, as a support substrate to provide structural support. The monolith 904 may be made of glass, a ceramic material, a gas permeable material, a functional fiber, or the like. The monolith 904 may be fabricated by various methods, including extrusion, molding, 3-dimensional printing, or the like.

The monolith 904 may have a plurality of passages 906. The plurality of passages 906 may be micro channels, for instance for airflow, and the number and size of the plurality of passages 906 may be determined based on the type of sorbent material used and the intended application, such as for CO2 or H₂O. The plurality of passages 906 may extend across the length of the monolith 904 to allow airflow in one direction. The plurality of passages 906 may extend in multiple directions to allow airflow in multiple directions through the sorbent structure 902. In some examples, the plurality of passages 906 may form a honeycomb configuration. The monolith 904 may be formed of a gas permeable material to allow air to flow through its surfaces.

The monolith 904 may have functionalized surfaces in which the surfaces of the monolith 904 are able to chemically bind with dilute material, such as CO₂ molecules in air. In some examples, the surfaces of the monolith 904 may be functionalized by coating or grafting the surfaces with sorbent material, chemically modifying the surface to have a covalent bond, or the like. In some examples, the monolith 904 may be fabricated using functionalized materials, such as CO₂-capturing fibers.

In some examples, the panel shaped sorbent structure 902 may be fabricated using a pellet bed or a packed bed. A pellet bed may include a container or an external casing having a flat plate shape and filled with pellets of sorbent material, such as porous ceramics, zeolites, or activated carbon coated with amines, such as CO₂-capturing moieties. The pellets may have a predetermined shape and size that allows gas to flow through the container. The pellets may be filled in the container, which may function as a support structure to pre-shape the pellets into the panels shape.

FIG. 9B depicts panel shaped sorbent structures 908, 910, and 912 that are made up of a plurality of sorbent structures, such as the sorbent structures 802 depicted in FIG. 8A to 8D. The sorbent structure 802 may be formed of sorbent material that is shaped into a predetermined form, such as a cylinder, or formed as an external casing that holds sorbent material in various physical forms, such as beads, pellets, powders, solvents, or the like. A plurality of sorbent structures 802 may be arranged adjacent to each other to form a panel shape. The panel shaped sorbent structure 908, 910, and 912 may be modular, which may enable the sorbent structures 802 to be transported separately, for instance in a vacuum tube 618, 814, and the sorbent structures 802 to be processed in batches inside a reactor chamber as a panel shaped sorbent structure 908, 910, and 912. In some examples, the transport mechanism may arrange the sorbent structures 802 in a predetermined arrangement or groups inside a regeneration chamber or an air contactor.

In some examples, a predetermined number of sorbent structures 802 may be arranged in a line to form the panel shape. The panel shaped sorbent structures 908 may include a single row of sorbent structures 802. The sorbent structures 802 may be positioned such that the curved surfaces are adjacent to each other, while the bases or faces are positioned parallel to each other. The number of sorbent structures 802 may be determined based on the size of the reactor chamber, the pattern of the electromagnetic energy inside the reactor chamber, the type of the sorbent material, the targeted compound, or the like.

The panel shaped sorbent structure 910 may include multiple lines of sorbent structure 802, as depicted in FIG. 9B, to form a panel-like shape. The panel shaped sorbent structure 910 may include additional rows of sorbent structure 802. The panel shaped sorbent structure 912 may have multiple rows of sorbent structure 802, as depicted in FIG. 9B. Each row may include a plurality of sorbent structures 802 arranged such that the bases of the cylinder shape are facing each other, and each row is arranged parallel to each other with the curved surfaces adjacent to each other. The panel shaped sorbent structure 912 may include additional rows or columns of the sorbent structure 802.

FIG. 9C depicts a panel shaped sorbent structures 914. The panel shaped sorbent structure 914 may include a tray 916, which may be a container to hold sorbent material 918. The tray 916 may have a panel shape to provide structural support to “shape” the sorbent material 918. The sorbent material 918 may be in various physical forms, such as beads, pellets, powder, liquid solvents, or the like that may be contained in the tray 916 and conform to the shape of the tray 916. The tray 916 may be a movable tray, which may be transported by the transport mechanism. For instance, the transport mechanism may move the tray 916 into a regeneration chamber, which may be optimized and tuned for desorbing sorbent structures having a plate shape. In some examples, the tray 916 may include gas-permeable surfaces to allow desorbed gases to escape.

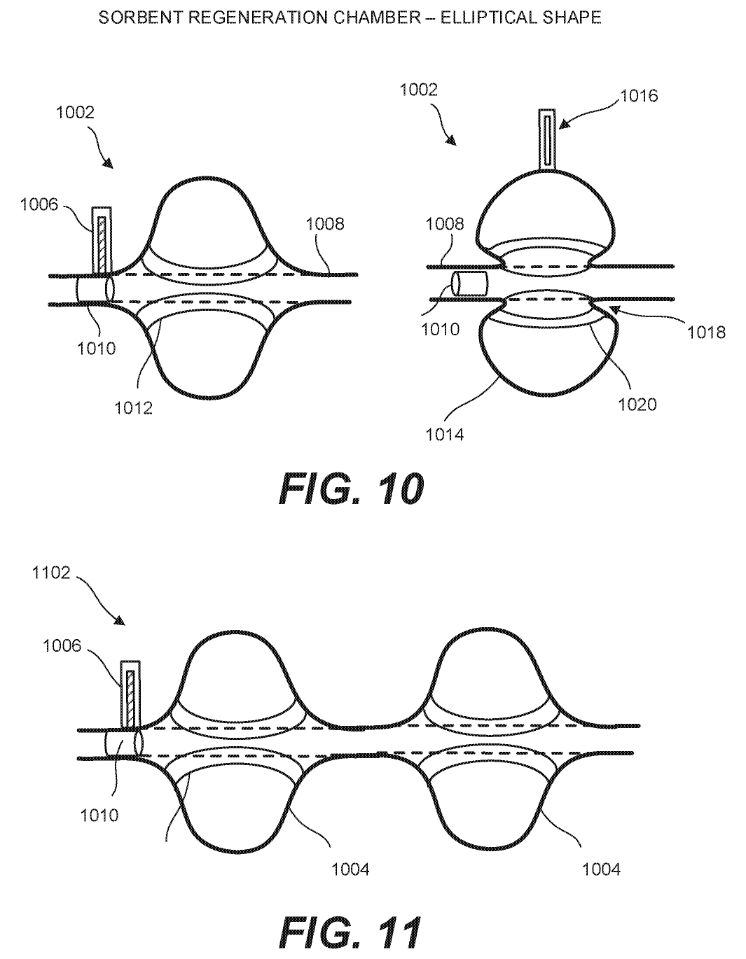

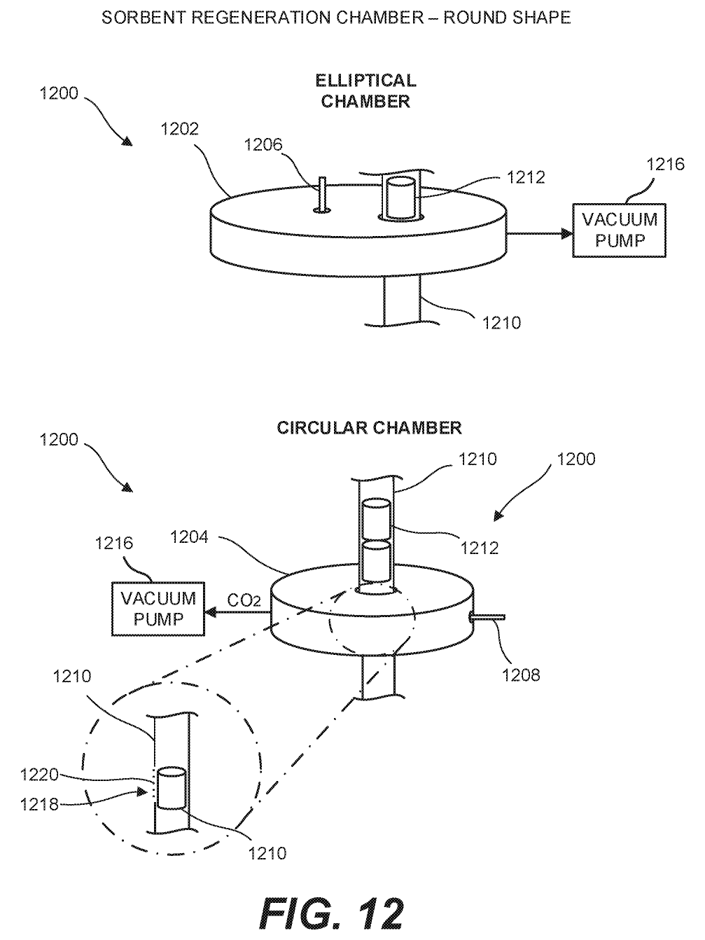

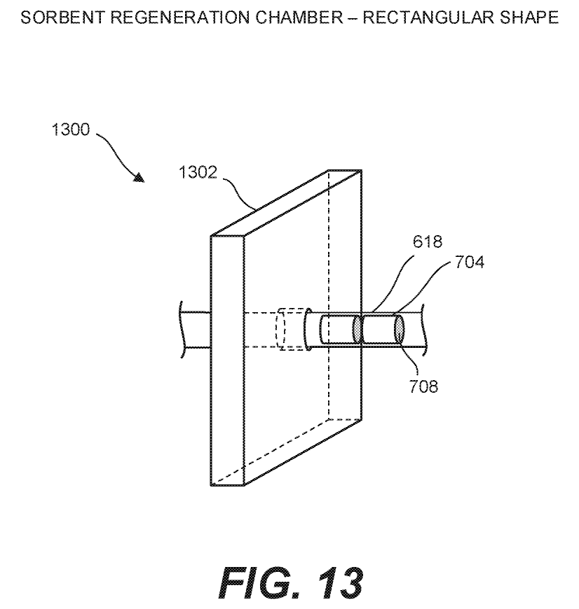

Reference is made to FIGS. 10 to 13. FIG. 10 depicts a diagram of example sorbent regeneration chambers 1002 and 1004 having an elliptical shape. FIG. 11 depicts a diagram of an example sorbent regeneration chamber 1006 having multiple cavities connected in series. FIG. 12 depicts a 3-dimensional perspective view of example sorbent regeneration chambers 1202, 1204 having a round shape. FIG. 13 depicts a 3-dimensional perspective view of an example sorbent regeneration chamber 1302 having a rectangular shape. It should be understood that the example sorbent regeneration chambers 1002, 1004. 1006, 1202, 1204, and 1302 may include additional features and that some of the features described herein may be removed and/or modified without departing from the scope of the sorbent regeneration chambers 1002, 1004. 1006, 1202, 1204, and 1302.

As depicted in FIG. 10, a sorbent regenerator 1002 may include a sorbent regeneration chamber 1004, an energy source 1006, a tube 1008 connected to the sorbent regeneration chamber 1004, through which a sorbent structure 1010 may pass through the sorbent regenerator 1002. The sorbent regenerator 1002 may be the same as the sorbent regenerator 612 depicted in FIG. 6.

The energy source 1006 may include an electric coupler that connects to the resonant cavity via a coax feed. The energy source 1006 may generate electromagnetic energy 1012 as standing waves. As adsorbate-rich sorbent structure 1010 enters the sorbent regeneration chamber 1004 via the tube 1008, the sorbents are heated by the electromagnetic energy 1012 to desorb the adsorbate.

The sorbent regeneration chamber 1004 may have a “bell-shaped” cavity, or an oval/oblong shape. The cavity may be made of a highly conductive material, such as copper, brass, silver-plated aluminum, or the like. The energy source 1006 may include an electric coupler, or antenna coupler, to generate an electromagnetic standing wave 1012. The electromagnetic standing wave 1012 may be concentrated along a path of the sorbent structure 1010 to maximize the energy directed at the sorbent material.

In some examples, the sorbent regenerator 1002 may include a sorbent regeneration chamber 1014, which may have a “nose-cone” type cavity. The nose-cone type cavity may have a rounded surface 1018, which may be the “nose” of the cavity. The rounded surface 1018 may be positioned at the transition between the walls of the cavity and a surface of the tube 1008. In some examples, the sorbent regenerator 1002 may include an energy source 1016 that includes a magnetic coupler, or loop coupler, to generate an electromagnetic standing wave 1020. The rounded surface 10018 may alter the position and pattern of the electromagnetic standing wave 1020 along the path of the sorbent structure 1010 through the resonant cavity. In some examples, the shape of the rounded surface, for instance the radius or length, may be changed to change the shape of the standing waves inside the cavity, which in turn may change the distribution of the electromagnetic energy in the path of the sorbent structure 1010. While FIG. 10 depicts the bell-shaped cavity coupled to the electric coupler and the nose-cone cavity coupled to the magnetic coupler, it should be appreciated that the sorbent regenerator 1002 may have the bell-shaped cavity coupled with the magnetic coupler.

As depicted in FIG. 11, a sorbent regenerator 1102 may have a plurality of sorbent regeneration chambers 1004 connected in series. This arrangement may be referred to as a “pillbox” configuration or pillbox cavities. The energy source 1006 or the energy source 1016 may be coupled to the series of sorbent regeneration chambers 1004. In some examples, a plurality of energy sources 1006, 1016 may be provided. The sorbent material 1010 may pass through each of the plurality of sorbent regeneration chambers 1004, which may be tuned differently from each other.

As depicted in FIG. 12, a sorbent regenerator 1200 may have a regeneration chamber 1202, 1204 that has a round shape. The sorbent regenerator 1200 may be the same as the sorbent regenerator 612 depicted in FIG. 6. The sorbent regeneration chamber 1202 has an elliptical shape and the sorbent regeneration chamber 1204 has a circular shape. An antenna 1206, 1208 may generate an electromagnetic field inside the sorbent regeneration chamber 1202,1204. The electromagnetic field inside the sorbent regeneration chamber 1202,1204 may be in a Transverse Magnetic 010 mode (TM010 mode). TM010 mode refers to the lowest resonant mode of an antenna, in which electric field lines are primarily oriented along a length with no variation in the magnetic field along that length.

For instance, in TM010 mode, the antenna 1208 may generate the electromagnetic field in a standing wave pattern that is concentrated at the center of the sorbent regeneration chamber 1204, along the path of the sorbent structure 1212 at the feedline 1210. The sorbent regeneration chamber 1202 having an elliptical shape may also generate electromagnetic fields in TM010 mode. The sorbent regeneration chamber 1202 may be tuned based on the positioning of the antenna 1206, electric and/or magnetic coupling, and the dimensions of the cavity to order to fine tune the location of the standing wave pattern inside the cavity. By tuning the sorbent regeneration chamber 1202 such that the standing wave pattern is located at the feedline 1210, the electromagnetic energy may be concentrated along sorbent structure 1212, which in turn may improve efficiency in heating the sorbent material.

The sorbent regenerator 1200 may include a vacuum pump 1216 to capture desorbed gases, such as CO₂. The vacuum pump 1216 may be positioned at a peak point of desorption in the sorbent regeneration chamber 1202, 1204 in order to maximize gas collection. In some examples, an opening 1218 may be disposed on a surface of the feedline 1210, inside the sorbent regeneration chamber 1202, 1204. A mesh cover 1220 may be disposed to cover the opening 1218 to allow desorbed gases to exit the feedline 1210.

As depicted in FIG. 13, a sorbent regenerator 1300 may have a sorbent regeneration chamber 1302 that has a rectangular shape. The sorbent regeneration chamber 1302 may be implemented as a rectangular waveguide. In some examples, the sorbent regeneration chamber 614 depicted in FIG. 6 may be implemented as the sorbent regeneration chamber 1302. The rectangular waveguide may provide flexibility in the range of frequencies of the electromagnetic energy waves. For example, different frequencies may be appropriate based on the types of application and the sorbent material to be used, such as for CO₂ and H₂O. The rectangular wave guide may be compatible with different frequencies appropriate for different types of chemical compounds that are targeted.

In some examples, the sorbent regeneration chamber 1302 may include a door mechanism (not shown) to maintain a vacuum in the feedline 1210. In some examples, the sorbent structure 704 may include the non-porous ends 708, as depicted in FIG. 7E, which provides a vacuum seal.

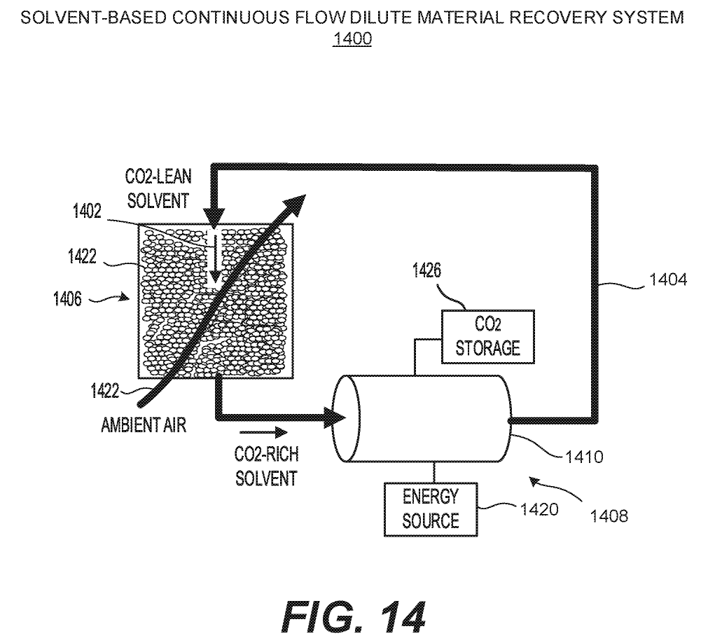

Reference is made to FIG. 14. FIG. 14 depicts a 3-dimensional perspective view of an example solvent-based continuous flow dilute material recovery system 1400. It should be understood that the example solvent-based continuous flow dilute material recovery system 1400 may include additional features and that some of the features described herein may be removed and/or modified without departing from the scope of the solvent-based continuous flow dilute material recovery system 1400.

As depicted in FIG. 14, the solvent-based continuous flow dilute material recovery system 1400 may include solvent 1402 that flows through a tube 1404. The solvent-based continuous flow dilute material recovery system 1400 may include an air contactor 1406 and a sorbent regenerator 1408. In some examples, the sorbent regenerator 1408 may be the same as the sorbent regenerator 612 depicted in FIG. 6. The sorbent regenerator 1408 may include a sorbent regeneration chamber 1410 and an energy source 1420 disposed to emit electromagnetic energy at the solvent 1402 as the solvent 1402 passes through the sorbent regeneration chamber 1410. The tube 1404 may be connected between the air contactor 1406 and the sorbent regenerator 1408 to circulate the solvent 1402 between the air contactor 1406 and the sorbent regenerator 1408. The solvent 1402 may be disposed inside the tube 1402 to continuously circulate between the air contactor 1406 and the sorbent regenerator 1408.

The solvent 1402 may include aqueous or non-aqueous solutions. In this case, the air contactor 1406 may be based on cross-flow gas-filled contactor filled with packing materials 1422. By way of particular example and for purposes of explanation, the solvent-based continuous flow dilute material recovery system 1400 may be implemented to capture CO_{2.} In this instance, the solvent 1402 may include CO₂-capturing moieties, which are dissolved or suspended in the aqueous or non-aqueous solutions to chemically bind with CO₂ molecules upon contacting air 1424. As the solvent 1402 circulates in the tube 1404, CO₂–lean solvent 1402 from the sorbent regenerator 1408 may enter the air contactor 1406. The solvent 1402 may capture CO₂ in the air contactor 1406, then CO₂–rich solvent 1402 may flow into the sorbent regeneration chamber 1410.

In some examples, a pump (not shown) may be connected to the tube 1404 to create flow in the tube 1404. In some examples, the tube 1404 may be under vacuum to create the flow of solvent 1402 in the tube 1404. The sorbent regenerator 1408 may include a collection chamber 1426 connected to the sorbent regeneration chamber 1410. The collection chamber 1426 may collect and store captured CO₂ from the headspace inside the sorbent regeneration chamber 1410 during microwave application.

For purposes of explanation, the solvent-based continuous flow dilute material recovery system 1400 is described above for CO₂ capture from ambient air. It should be understood, however, that the present disclosure is not limited to CO₂, and may be applicable for capturing various types of compounds or contaminants using solvents 1402, such as water harvesting from ambient air, volatile organic compound (VOC) removal, and/or the like.

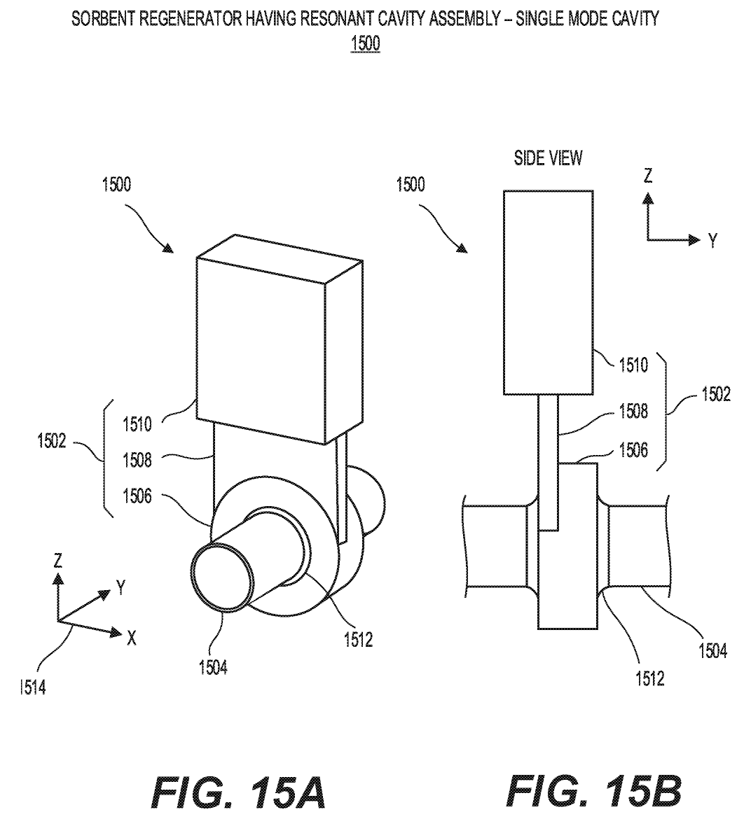

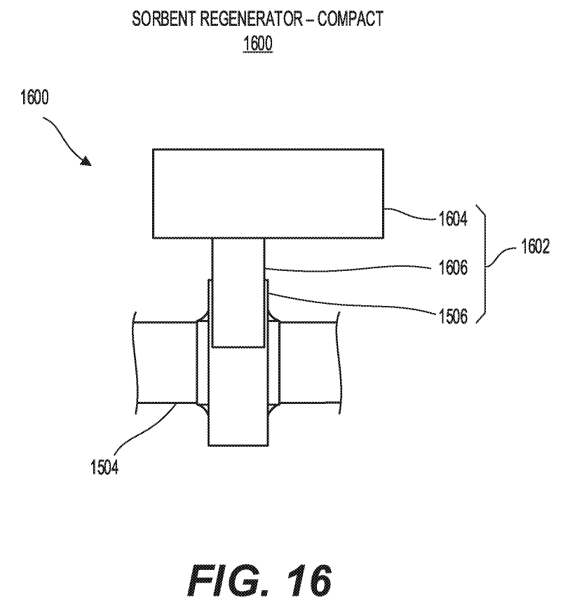

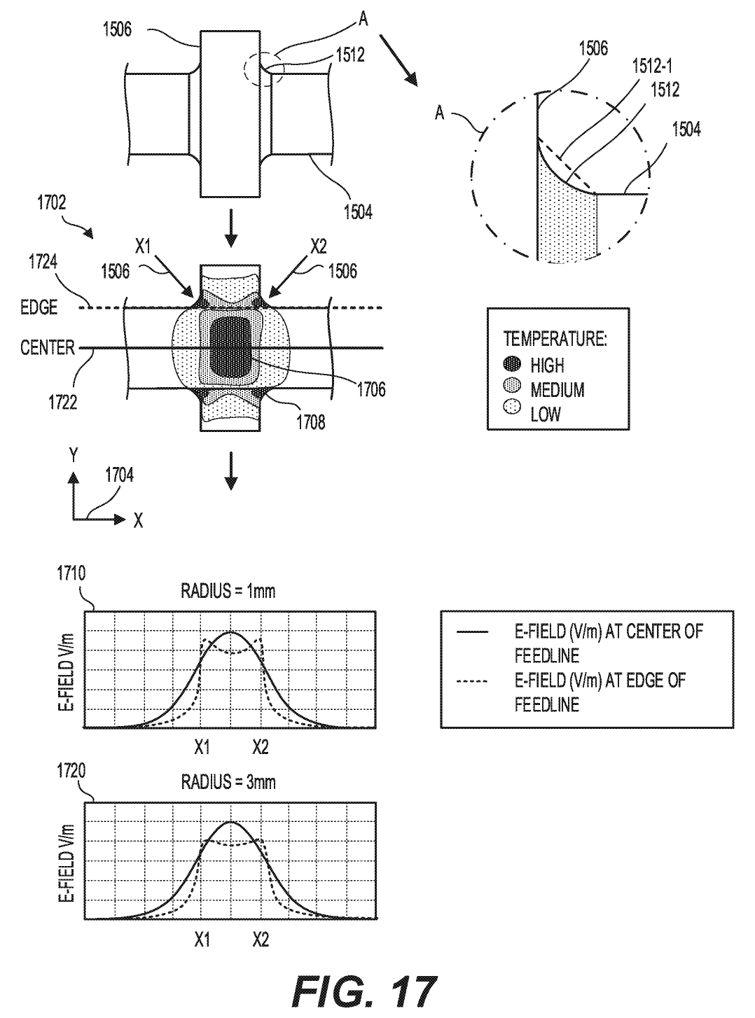

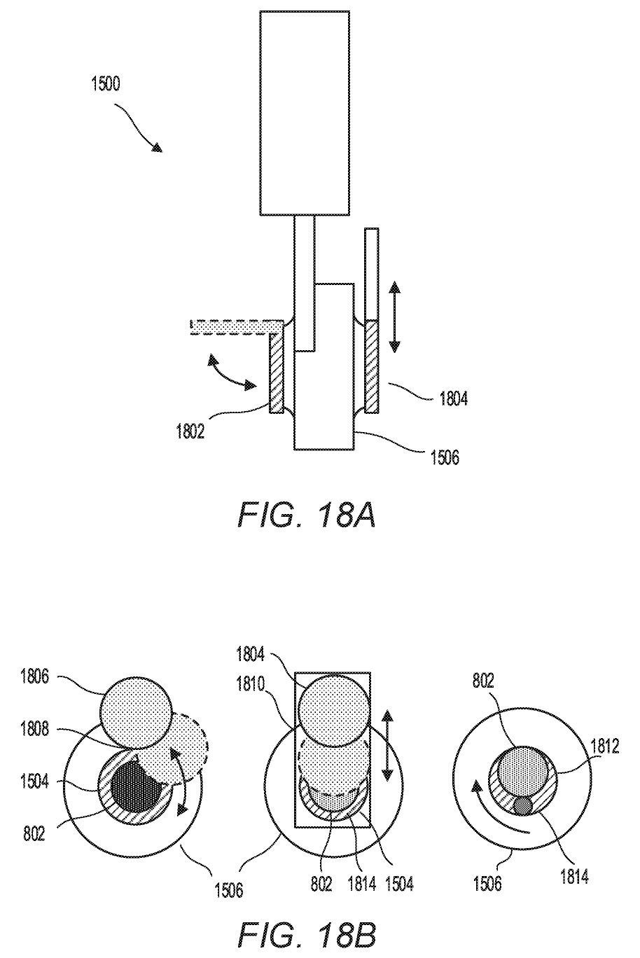

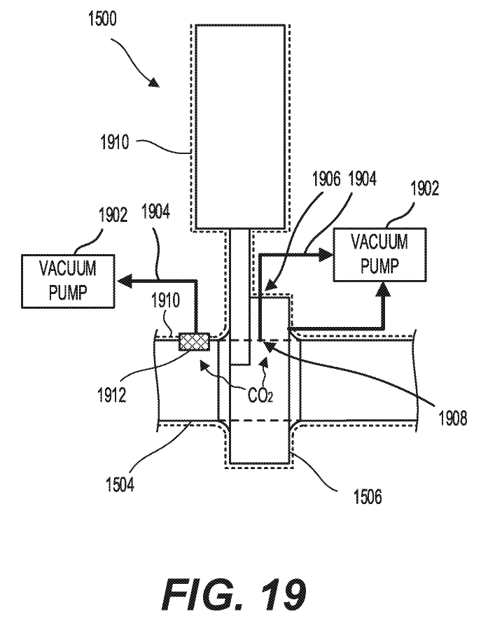

Reference is made to FIGS. 15A to 15B, FIGS. 16 to 17, FIGS. 18A to 18B, and FIG. 19. FIG. 15A depicts a 3-dimensional perspective view of the example sorbent regenerator 1500. FIG. 15B depicts a 3-dimensional side view of the sorbent regenerator 1500 depicted in FIG. 15A. FIG. 16 depicts a side view of an example sorbent regenerator 1600 having a waveguide 1510 in a horizontal position. FIG. 17 depicts a diagram of an example sorbent regeneration chamber 1506 having a flared surface 1512. FIG. 18A depicts a side view of an example sorbent regenerator 1500 having vacuum sealing doors 1802, 1804. FIG. 18B depicts a cross-sectional view of an example sorbent regeneration chamber 1506 with vacuum sealing doors 1804, 1806. FIG. 19 depicts a side view of an example sorbent regenerator 1500 that includes vacuum pumps 1902. It should be understood that the example sorbent regenerators 1500 and 1600 and the example sorbent regeneration chamber 1506 may include additional features and that some of the features described herein may be removed and/or modified without departing from the scope of the sorbent regenerators 1500 and 1600 and the sorbent regeneration chamber 1506.

FIG. 15A depicts a 3-dimensional perspective view of an example sorbent regenerator 1500 that includes a resonant cavity assembly 1502. The sorbent regenerator 1500 may be a modular RF/MW-assisted desorber based on a single-mode cavity. The resonant cavity assembly 1502 includes a sorbent regeneration chamber 1506, an input waveguide 1510, and a matching wave guide disposed between the sorbent regeneration chamber 1506 and the input waveguide 1510.

The sorbent regeneration chamber 1506 may be a cylindrical resonant cavity. The sorbent regeneration chamber 1506 may be integrated with a feedline 1504 and a vacuum line (not shown) connected to a vacuum pump (not shown). The feedline 1504 is also referred to herein as a tube, which may be the same as the tube 618 depicted in FIG. 6 and the tube 1404 depicted in FIG. 14. The sorbent regeneration chamber 1506 may have a “flared” surface 1512 or flared connection with the feedline 1504. In some examples, the sorbent regenerator 1500 may be referred to herein as a flared regenerator when the flared surface 1512 is installed. The flared surface 1512 may improve electromagnetic field distribution, which results in a more even sample treatment. It should be appreciated, however, that the sorbent regenerator 1600 may be implemented without the flared surface.

By way of particular example and for purposes of explanation, the sorbent regenerator 1500 may be designed to work with 2.45 GHz but this same design may be made to work with any RF/MW frequencies in the Industrial, Scientific, and Medical (ISM) band by adjusting the physical dimensions. The feedline 1504 may have a diameter of 42mm, the sorbent structure 802 may have a diameter of 40mm, and the sorbent regeneration chamber 1506 may have a resonant cavity that is about 83.7mm x 30mm. In some examples, the enhanced flexibility and robustness of resonant cavity assembly 1502 of the sorbent regenerator 1500 may allow multiple energy sources to be connected through multiple matching waveguide connections 1508, 1510, allow a wider range of sorbent material to be compatible, and enable a more even distribution of heat across the sorbent material, all of which may improve the efficiency of the dilute material recovery systems.

FIG. 15B depicts a side view of the example sorbent regenerator 1500 having the resonant cavity assembly 1502 and the flared surface 1512. The flared surface 1512 may be a connection at a junction between the feedline 1504 passage and a surface of the sorbent regeneration chamber 1506. The flared surface 1512 may be tuned, for instance based on its shape and size, to more evenly distribute the electromagnetic energy inside the sorbent regeneration chamber 1506, and in turn the sorbent structure 802 as the sorbent structure 802 passes through the feedline 1504.

FIG. 16 depicts a side view of an example sorbent regenerator 1600 having resonant cavity assembly 1602 in which an input waveguide 1604 is in a horizontal position. The input waveguide 1604 may be similar to the input waveguide 1510 depicted in FIG. 15. However, the input wave guide 1510 is vertically oriented. In some cases, it may be desirable to have a more compact configuration, such as when installation space is limited. In this regard, the input waveguide 1604 may be connected in the horizontal direction, which may potentially save space. In some examples, the size, e.g., the length and/or height, of the input waveguide 1604 may also be changed. In these instances, the matching waveguide 1606 may be tuned accordingly to the changed parameters of the input wave guide 1604.

FIG. 17 depicts a diagram of an example sorbent regeneration chamber 1506 having a flared surface 1512. As previously described with respect to FIGS. 15A and 15B, the flared surface 1512 may improve distribution of the electromagnetic waves inside the resonant cavity. As depicted in the enlarged portion A, the flared surface 1512 may be curved between a surface of the sorbent regeneration chamber 1506 and a surface of the feedline 1504. This junction would normally have a sharp corner, for instance, a 90 degree intersection. By smoothing the surface at this junction, the standing wave pattern inside the resonant cavity may be tuned to increase RF/MW energy at the edges of the resonant cavity to levels closer to RF/MW energy at the center of the resonant cavity, resulting in more evenly distributed energy.

A heat map 1702 may be a proxy to confirm the changes in the energy distribution. The heat map 1702 depicts the variation in temperature within the sorbent regeneration chamber 1506. With reference to the 2-D axis 1704 and the 3-dimensional axis 1514 depicted in FIG. 15A, the heat map 1702 depicts variations in the X-Y plane, along a center of the chamber in the z-direction. The region 1706 represents the center of the resonant cavity and has the highest temperatures. The region 1708, which correlates to the position of the flared surface 1512, also has the highest temperatures.

The behavior at the edges of the resonant cavity is illustrated by graphs 1710 and 1720. The graphs 1710, 1720 depict the electric field strength in the X-direction, along the center line 1722 and the edge line 1724, represented by the solid and dotted lines, respectively. The center line 1722 runs along the center of the feedline 1504. The edge line 1724 runs along the edge of the feedline 1504.

Graph 1710 is based on the flared surface 1512 having a radius R of 1mm. As shown in graph 1710, the strength of the electric field at Point X11506 and Point X21506 are nearly as high as the maximum electric field strength at the center. By way of particular example and for purposes of explanation, the electric field strength at point X may be about 4.5e+07 V/m, and at the center of the center line 1722 may be about 4.9e+07 V/m. However, the electric field strength at the edge line 1724 between X1 and X2 drops to about 3.8e+07 V/m.

Graph 1720 is based on the flared surface 1512 having a radius R of 3mm. As shown in graph 1720, the strength of the electric field at Point X11506 and Point X21506 are lower than in graph 1720, but the electric field strength across the resonant cavity at the edge 1724 is more evenly distributed. By way of particular example and for purposes of explanation, the electric field strength at Point X1 and Point X2 are about 4.0e+07 V/m. However, the electric field strength at the center of the edge line 1724 between X1 and X2 is about 3.7e+07 V/m.

The electromagnetic field strength and distribution in the resonant cavity may be adjusted by adjusting the radius R of the flare surface 1512, which may provide additional controllability to co-optimize the sorbent regenerator 1500 based on geometry and dielectric properties of the sorbent material. In some examples, the flare surface 1512-1 may be a straight or flat surface, or a simple taper, as opposed to a curved surface.

FIG. 18A depicts a side view of an example sorbent regenerator 1500 having vacuum sealing doors 1802 and 1804. FIG. 18B depicts a cross-sectional view of an example sorbent regeneration chamber 1506 with vacuum sealing doors 1804 and 1806. In some examples, a sorbent material, such as the sorbent structure 802, may be placed inside a vacuum cavity of the sorbent regeneration chamber 1506, rather than being fed into the sorbent regeneration chamber 1506. In these instances, a vacuum-compatible doors may enable a vacuum state to be maintained in the sorbent regeneration chamber 1506. The vacuum-compatible doors may have various configurations. The vacuum sealing door 1802 may be a hinged or swing type, which is connected to the body of the sorbent regeneration chamber 1506 walls via a hinge such that it swing outward in an outward arc. The vacuum sealing door 1804 may be a linear sliding type that slides in a linear direction, for instance, vertically up or down. In some examples, a track 1810 may guide the vacuum sealing door 1804 in the intended lateral direction. The vacuum sealing door 1806 may be a pivot or rotary type, in which the vacuum sealing door 1806 is rotatably fixed to rotate parallel to the sorbent regeneration chamber 1506 wall at the opening.

In some examples, the sorbent structure 802 may either fully or partially fill the resonant cavity. For instance, the diameter of the sorbent structure 802 may be smaller than the diameter of the feedline 1504. The size and amount of rotation may be determined based on the properties of the sorbent material. In some examples, the diameter of the sorbent structure 802 may be smaller than the diameter of the feedline 1812, and the sorbent structure 802 may be positioned off-center, for instance to contact a surface of the feedline 1812. A spacer 1814 made of RF/MW transparent material may be disposed inside the cavity to position the sorbent structure 802 at a particular location inside the cavity. For instance, the spacer 1814 may have a ring shape that surrounds the sorbent structure 802 or may have a cylindrical shape to be positioned adjacent to the sorbent structure 802.

The sorbent structure 802 may be rotated at a fixed speed or a variable speed in order to more evenly process the entire volume of the sorbent structure 802. The distribution of electromagnetic energy inside a resonant cavity, and thus on the sorbent structure 802, may be uneven. The tendency in a resonant cavity is that a power gradient is formed between the center of the cavity and the walls, such that the electromagnetic energy is concentrated in the center of the cavity, while being lower at the edges of the cavity along the walls. As such, the sorbent material may heat unevenly when the sorbent structure 802 is stationary inside the cavity. By rotating the sorbent structure 802, all of the regions of the sorbent structure 802 may pass through the relatively hotter regions, and thus a relatively more even heat distribution may be achieved. In some examples, the sorbent structure 802 may be rotated by a mechanism attached to the sorbent structure 802 from the outside of the sorbent regeneration chamber 1506. In some examples, the feedline 1812 may be rotated to cause the sorbent structure 802 to rotate. The feedline 1812 may also have grooves or ridges formed on the inner walls to grip and rotate the sorbent structure 802.

FIG. 19 depicts a side view of an example sorbent regenerator 1500 that includes a vacuum pump 1902. A vacuum pump 1902 may enable collection of CO₂ with less contaminants. Moreover, collection closest to the source of the CO₂ may yield best results, with the least amount of contaminants. In some examples, a vacuum line 1904 may be connected to a middle section 1908 of the feedline 1504, through the waveguide or cavity wall 1906. A connection at the middle section 1908 of the feedline 1504 may ensure that the vacuum line 1904 is connected at the point of peak desorption, near the center of the regeneration chamber 1506.

In some instances, it may be difficult to access the middle section 1908, in which case the vacuum line 1904 may be installed at other locations. The sorbent regenerator 1500 made be made entirely of metal components, and access to middle section 1908 may require drilling through certain thick metal components, which may be difficult or undesirable. In some instances, even when some components are not made of metal, such as certain feedlines 1504, they may still be covered with a metallic material to shield from potential RF/MW losses. In some examples, the entire body of the sorbent regenerator 1500 may be covered by a metallic wall 1910.

However, some areas of the system may be more suitable for drilling than some others. In order to attach the vacuum line 1904, a hole may be drilled through the metallic wall 1910 to access the inner cavity. A size of the hole may be adjusted for gas conductance or flow and for RF/MW power leakage prevention. A metal mesh 1912 may be added to prevent RF/MW power leakage without blocking gas flow through the waveguide/reactor walls, for instance, the metallic wall 1910. In some examples, the vacuum line 1904 may be connected near the joint between the sorbent regeneration chamber 1506 wall and the feedline 1504. The vacuum line 1904 may be installed on the feedline 1504, outside of the RF system. The vacuum pump 1902 may be connected to a single vacuum line 1904 or to multiple vacuum lines 1904, and multiple vacuum pumps 1902 may be installed.

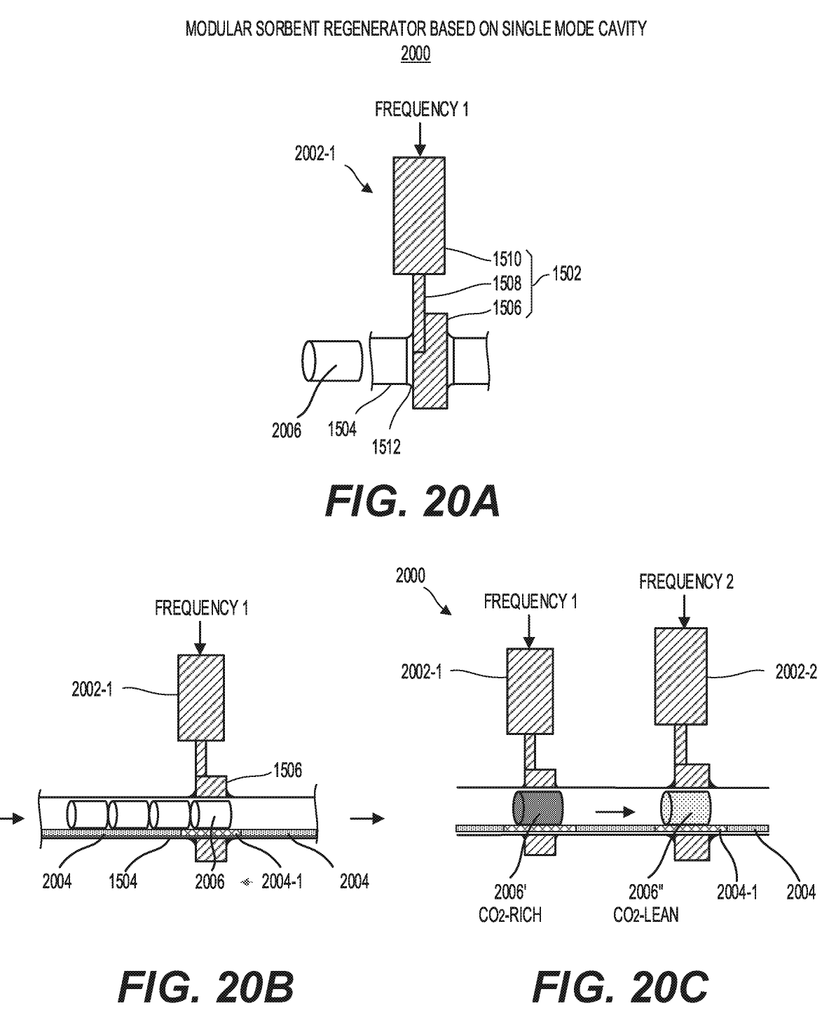

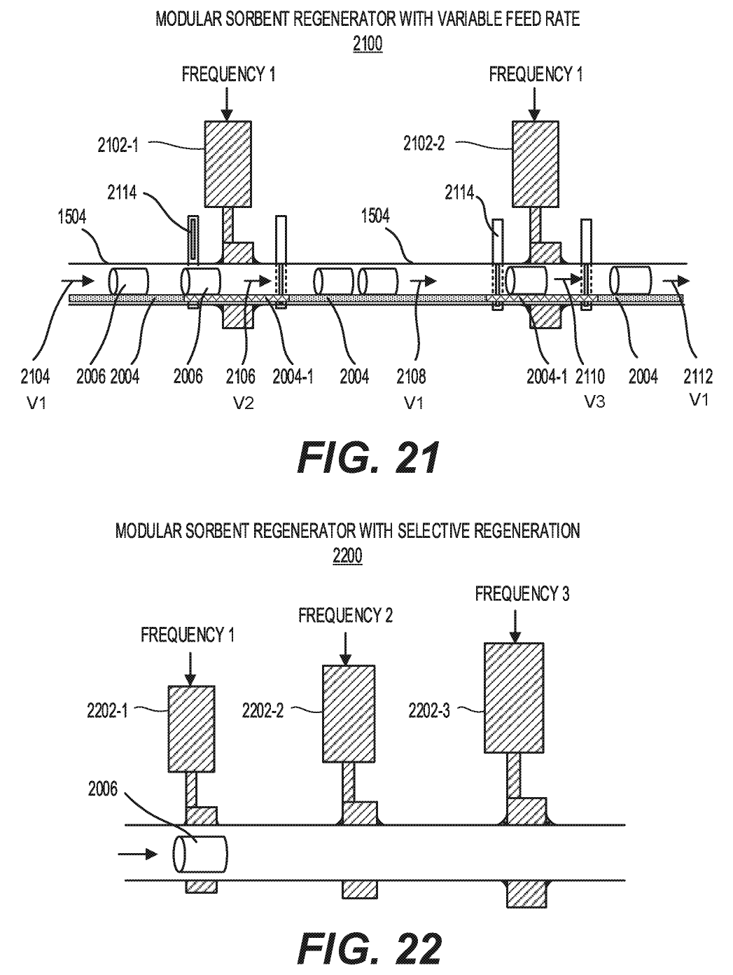

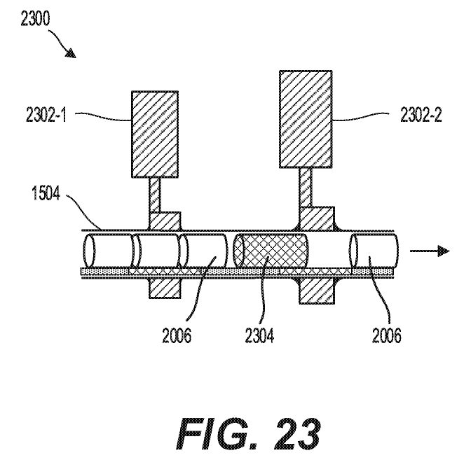

Reference is made to FIGS. 20A to 23. FIG. 20A depicts a diagram of an example modular sorbent regenerator 2000 including a sorbent regenerator 2002-1 having a single-mode cavity. FIG. 20B depicts a diagram of an example modular sorbent regenerator 2000 including a sorbent regenerator 2002-1 and a sorbent feeding mechanism 2004. FIG. 20C depicts a diagram of an example modular sorbent regenerator 2000 having multiple sorbent regenerators 2002-1 and 2002-2 connected in series. FIG. 21 depicts a diagram of an example modular sorbent regenerator 2100 that modulates feed rates of sorbent structures 802. FIG. 22 depicts a diagram of an example modular sorbent regenerator 2200 including a plurality of sorbent regenerators 2202-1, 2202-2, 2202-3 connected in a multi-cell configuration, in which each cell is tuned for a different input frequency. FIG. 23 depicts a diagram of an example modular sorbent regenerator 2300 that includes multiple sorbent generators 2302-1, 2302-2 and a spacer 2304 disposed between adjacent sorbent structures 2006 to maintain an air/vacuum gap to minimize RF/MW power leaks. It should be understood that the example modular sorbent regenerators 2000, 2100, and 2200 may include additional features and that some of the features described herein may be removed and/or modified without departing from the scope of the modular sorbent regenerators 2000, 2100, and 2200.

FIG. 20A depicts a sorbent regenerator 2002-1 of a modular sorbent regenerator 2000. The sorbent regenerator 2002-1 may be a modular RF/MW-assisted desorber based on a single-mode cavity. The sorbent regenerator 2002-1 may be the same as the sorbent regenerator 1500 depicted in FIGS. 15A and 15B. The sorbent regenerator 2002-1, or desorber, may be compatible with various sorbent structures such as those having cylindrical or spherical shapes and fabricated from spiral-woven membrane/mesh, cylindrical monolith, 3-dimensional printed structures, pill-shaped structures, pod-shaped structures, or the like. The sorbent structure 2006 may be the same as, for instance, the sorbent structures 702, 704, and 802 depicted in FIGS. 7A to 7F and 8A to 8F, all of which are compatible with the sorbent regenerator 2002-1.

The sorbent regenerator 2002-1 may have a single mode cavity. The sorbent regenerator 2002-1 may include a resonant cavity assembly 1502 that includes a sorbent regeneration chamber 1506, an input waveguide 1510, and a matching waveguide 1508. The implementation of the input waveguide 1510 and the matching waveguide 1508 may provide improved power delivery and performance. The resonant cavity assembly 1502 may be tuned for a specific sorbent material and a specific frequency range, and may enable increased flexibility and applicability to a greater number of sorbent materials. An optimally positioned waveguide input port may allow increased uniformity, allow for multi-port power application, and enable dynamic phase control.

A flared design including the flared surface 1512 may improve uniformity of the electromagnetic energy inside the resonant cavity, particularly near the edges of the sorbent structure 2006 where most materials may be located. This may contrast with cylindrical cavities without flared surfaces, which may suffer uniformity, especially near the edges.

The sorbent regenerator 2002-1 may be used with a wide range of ISM frequencies by flexibly adjusting the dimensions of the resonant cavity assembly 1502. This configuration may also provide minimum energy loss through wall heating and leakage, which may be <0.001% in some instances. This configuration may allow for active frequency control to maximize power coupling while minimizing reflection, and may allow for additional heating uniformity through adjusting the sorbent size and geometry. By way of particular example and for purposes of description, the sorbent regenerator 2002-1 as depicted in FIG. 20A may be rated for ~10kW input power. If higher power is desired, the cavity may be modified to have more of a “donut”-shape in order to handle the increased power, such as in some nosecone designs.

FIG. 20B depicts a diagram of an example modular sorbent regenerator 2000 including a sorbent regenerator 2002-1 and a sorbent feeding mechanism 2004. FIG. 20C depicts a diagram of an example modular sorbent regenerator 2000 including multiple sorbent regenerators 2002-1 and 2002-2 connected in series. Each of the sorbent regenerators 2002-1, 2002-2 may be referred to as cells within the modular sorbent regenerator 2000. Shaped sorbents, such as sorbent structure 2006, may be fed into the modular sorbent regenerator 2000 via the feeding mechanism 2004. The feeding mechanism 2004 may be referred to herein as a feeding system or a transport mechanism. The feeding mechanism 2004 may be a conveyor belt system that transports the sorbent structures 2006 into the sorbent regenerators 2002-1, 2002-2. The feeding mechanism 2004 may be divided into sections, each of which may operate at different feeding rates. For instance, an auxiliary feeding mechanism 2004-1 may be disposed inside the regeneration chamber 1506 and may separately adjust the speed of the sorbent structure 2006 as it passes through the regeneration chamber 1506. In some examples, the feeding mechanism 2004 may include other types of transport mechanisms, such as gravity-based and/or mechanical apparatuses such as pulleys or linear actuators.

Sorbent structures 2006 may be introduced into the modular sorbent regenerator 2000 continuously or in a batch mode. Continuous feeding may be modulated to vary residence time of each sorbent structure 2006 within the cells to increase efficiency or when the sorbent structure 2006 is to be processed in different cells connected in series. In some examples, the modular sorbent regenerator 2000 may include a single cell 2002-1 for microwave-assisted desorption. The modular sorbent regenerator 2000 may include multiple cells 2002-1, 2002-2 connected in series. In some examples, each of the cells 2002-1, 2002-2 may be optimized for disparate dielectric properties of the sorbent material upon desorption. As sorbent material is heated for desorption, it may become microwave transparent. The dielectric properties of sorbents thus changes during desorption, which could affect efficiency at a specific frequency. In these instances, the cells, sorbent regenerators 2002-1 and 2002-2, may be optimized for different frequencies. Each sorbent structure 2006 may be desorbed in multiple cells as it passes through a group or array of cells connected in series. As depicted in FIG. 20C, the CO₂-rich sorbent structure 2006’ may undergo desorption in sorbent regenerator 2002-1 at Frequency 1. Once the dielectric properties have pass a certain threshold, the now CO2-lean sorbent structure 2006” may be passed to the next cell, the sorbent regenerator 2002-2, which is optimized for Frequency 2, which is appropriate for the new dialectic property. In this manner, the efficiency of desorption may be improved.

FIG. 21 depicts a diagram of example modular sorbent regenerator 2100 that modulates feed rates of sorbent structures 2102-1, 2102-2. The modular sorbent regenerator 2100 may include a feeding mechanism 2004. The feeding mechanism 2004 may include an auxiliary feeding mechanism 2004-1, which may be disposed to control the feed rate inside the sorbent regenerators 2102-1, 2102-2. The auxiliary feeding mechanism 2004-1 may vary the feed rate at a different speed than the main feeding mechanism 2004.

By way of particular example, the modular sorbent regenerator 2100 may include two cells connected in series, specifically the sorbent regenerators 2102-1 and 2102-2. The sorbent structures 2006 may be moved through the each of the sorbent regenerators 2102-1, 2102-2 based on a modulated continuous feeding. The whole set of sorbent structures 2006 may be continuously fed at a first speed V12104 to the series of cells. Within each cell, the feeding rates may be modulated to desorb adsorbates with increased efficiency, desorption efficiency across the volume, and total cyclic capacity. For instance, the feeding mechanism 2004-1 in the sorbent regenerator 2102-1 may change the feed rate to a second speed V22106 based on, for example, the dielectric properties of the sorbent structure 2006. Once the sorbent structure 2006 exits the first cell, the feed rate may resume at the first speed V12108. Once the sorbent structure 2006 enters the second cell, the sorbent regenerator 2102-2, the feeing mechanism 2004-1 may change the feed rate to a third speed V32110, based on the characteristics of the sorbent structure 2006. The feed rate may return to the V12112 once the sorbent structure 2006 exits the second cell.

In some examples, movable vacuum seals 2114 may be installed to improve gas collection efficiency and reduce energy demand. The vacuum seals 2114 may slide vertically to open and close the feedline 1504. The vacuum seals 2114 may include supports, such as guide rails, to enable the vacuum seals 2114 to be movable. In some examples, the sorbent structures 2006 may have non-porous end 708, as depicted in FIG. 7E, which may enable a vacuum seal in the feedline 1504.

FIG. 22 depicts a diagram of an example modular sorbent regenerator 2200 including a plurality of sorbent regenerators 2202-1, 2202-1, 2202-3 connected in a multi-cell configuration. The modular sorbent regenerator 2200 may selectively regenerate a sorbent structure 2006 based on its properties. Each of the cells in the array may be tuned for a different input frequency. Each cell may be optimized for a certain type of sorbent material within a finite range of dielectric values (Ɛ’, Ɛ”). For example, each cell may have a different cavity diameter, dimensions, waveguide dimensions, or the like.

Upon receiving a sorbent structure 2006, each cell may determine whether to process the sorbent structure 2006 or to pass it onto the next cell. The first cell 2202-1 may transmit a low power signal, and sweep a low-high frequency range to detect the reflected signal. If a predetermined resonant frequency is detected, the first cell 2202-1 may send a high power signal to desorb the sorbent structure 2006. The first cell 2202-1 may continue to sweep for the resonant frequency during desorption. If it detects that the return signal from the sorbent structure 2006 is no longer within the resonant frequency, for instance, because the dielectric properties of the sorbent structure 2006 has changed during desorption, the first cell 2202-1 will pass the sorbent structure 2006 to the second cell, the second sorbent generator 2202-2. During the later stages of desorption, if the dielectric loss of the sorbent material has become too low to efficiently apply microwaves, for instance because of high power reflection, then water may be applied to the sorbent structure 2006 to increase microwave adsorption and accelerate desorption of last remaining amounts of CO₂. That is, during desorption, the sorbent material may lose its ability to efficiently desorb as the polar adsorbate, like water and CO_{2,} are removed. The addition of water during the final stages may reduce power reflection and aid in completing desorption during the late stages.

FIG. 23 depicts a diagram of an example modular sorbent regenerator 2300 that includes multiple cells, sorbent regenerators 2302-1, 2302-2, and a spacer 2304 disposed between adjacent sorbent structures 2006 to maintain an air/vacuum gap to minimize RF/MW power leaks from the cells. By way of particular example and for purposes of description, when using electromagnetic energy at a frequency near 2.45 GHz and the cavity thickness is about 30mm, the spacing between the cells greater than about 100mm may minimize interference. In order to reduce this distance between the cells, the cells may be co-optimized. In some instances, if the sorbent structures 2006 have a sufficient lengths and an air/vacuum gap is present between the sorbent structures 2006, a natural barrier may be formed that may prevent microwave waves from leaking into adjacent cells 2302-1, 2302-2. In some examples, the spacer 2302 may maintain the air/vacuum gap, which may minimize potential RF/MW power leaks from the cells 2302-1, 2302-2. The spacer 2304 may be made with microwave-transparent materials, such as polymers, glass, silica, PTFE, or the like. The spacer 2304 may be 3-dimensional printed, extruded, molded, or other appropriate low-cost method of construction may be used. In some examples, the spacer 2304 may be attached to the sorbent structure 2006 to provide additional mechanical support and provide interaction points with other mechanical structures that modulate feeding rates, such as feeding mechanisms 2004.

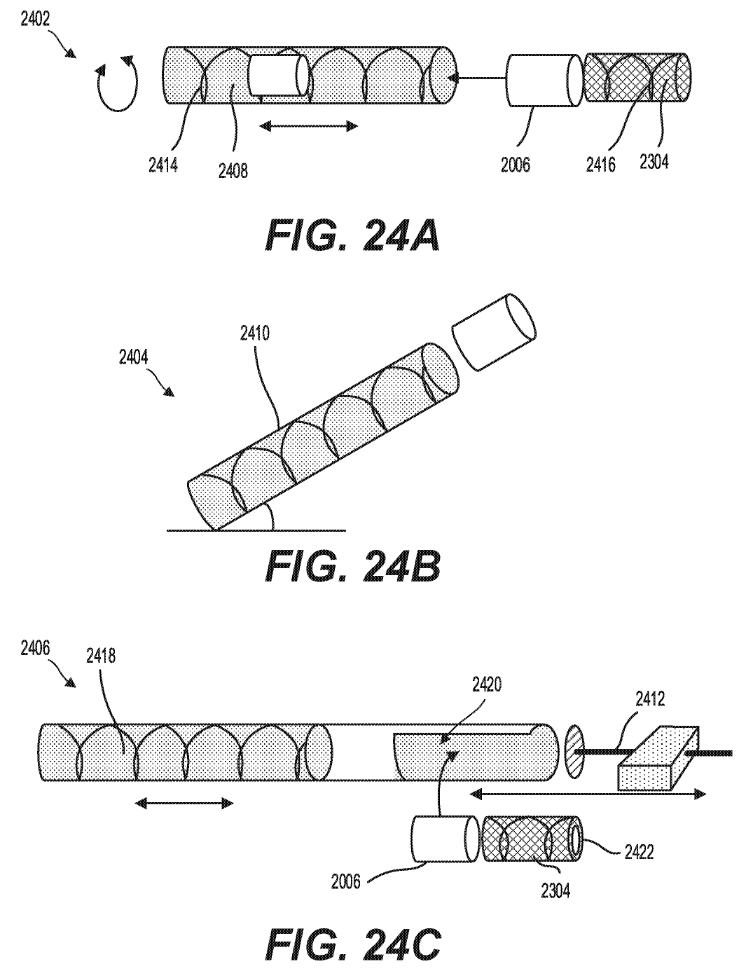

Reference is made to FIGS. 24A to 24C. FIG. 24A depicts a 3-dimensional perspective view of an example feeding mechanism 2402 that includes a rotary feedline 2408 to move sorbent structures 2006. FIG. 24B depicts a 3-dimensional perspective view of an example feeding mechanism 2404 that includes an angled feedline 2410 to move sorbent structures 2006 using gravitational feed. FIG. 24C depicts a 3-dimensional perspective view of an example feeding mechanism 2406 that includes a linear actuator 2412 to move sorbent structures 2006. It should be understood that the example feeding mechanisms 2402, 2404, 2406 may include additional features and that some of the features described herein may be removed and/or modified without departing from the scope of the feeding mechanisms 2402, 2404, 2406.

Each of the rotary type feeding mechanism 2402, the gravitational feeding mechanism 2404, and the linear actuator feeding mechanism 2406, similar to the feeding mechanism 2004 depicted in FIG. 20B, may be referred to herein as a feeding system or a transport mechanism. The feeding mechanisms 2402, 2404, and 2406 may transport the sorbent structures 2006 around a dilute material recovery system, such as sorbent regenerators and air contactors. In some examples, the feeding mechanisms 2402, 2404, and 2406 may be implemented in multiple sections that may operate at different feed rates. For instance, similar to the feeding mechanism 2004 and 2004-1 depicted in FIG. 21, an auxiliary rotary feeding mechanism 2402-1 may be disposed inside a regeneration chamber, such that the feed rate during desorption may be controlled independent from other sorbent structures outside of the reactor.

The feeding mechanism 2404 may use a rotational action of the feedline 2408 to laterally move the sorbent material 2006 along the feedline 2408. The feeding mechanism 2404 control the feed rate and reverse direction. The feedline 2408 may include guides 2414 provided on an inner surface of the feedline 2408. The guides 2414 may be grooves, rails, channels, or the like that mechanically engage with the sorbent structure 2006. The guides 2414 may be integrally formed on the feedline 2408 or it may be a separate structure that is mounted to the feedline 2006. In some examples, the sorbent structure 2006 may have structural features that interact with the guides 2414 to improve movement. For instance, the spacer 2404 may be attached to the sorbent structure 2006, and the spacer 2404 may have matching guides 2416 that engage with the guides 2414.

The feeding mechanism 2404 may include an angled feedline 2410 for gravitational feeding. The feedline 2410 may rotate in order to further control the movement of the sorbent structure 2006. The feedline 2410 may include the guides 2414 to improve control of the sorbent structure 2006.

The feeding mechanism 2406 may include a linear actuator 2412 to move the sorbent material 2006. The linear actuator 2412 may be coupled to a feedline 2418. The sorbent material 2006 may be inserted into an insertion port 2420 at the feedline 2418. The linear actuator 2412 may push the sorbent material 2006 into the feedline 2418. The linear actuator 2412 may be able to vary the feed rate as well as the direction of movement. In some examples, the linear actuator 2412 may be able to attach to the end of the sorbent structure 2006 so that it can control movement in both directions. The linear actuator 2412 may attach itself to the sorbent structure 2006 in various way, such as by magnetic force, mechanical connection via connectors, or the like. In some examples, the spacer 2404 may be attached to the sorbent structure 2006. The spacer 2404 may include a connection mechanism 2422 that may connect to the linear actuator 2412. In some examples, once connected to the sorbent structure 2006, the linear actuator 2412 may rotate the sorbent material within the feedline 2418, for instance, in order to improve distribution of heat during desorption as previously described with reference to FIG. 18B.

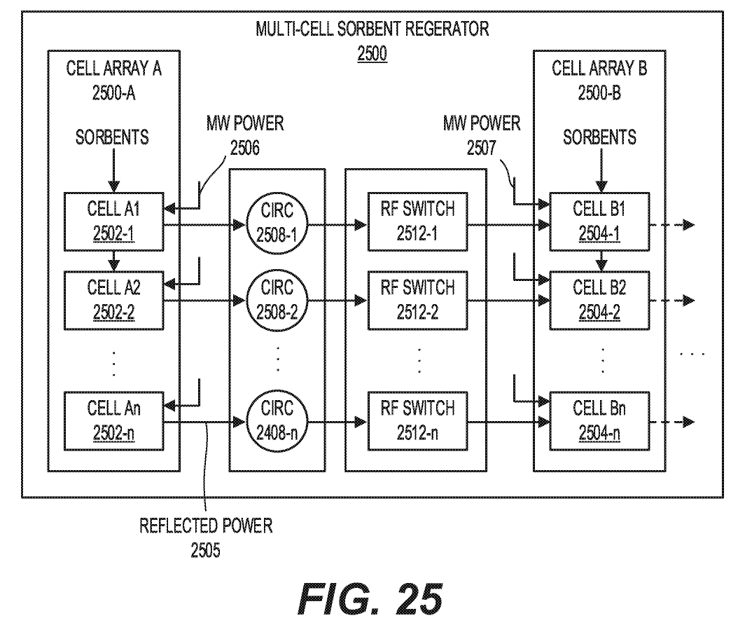

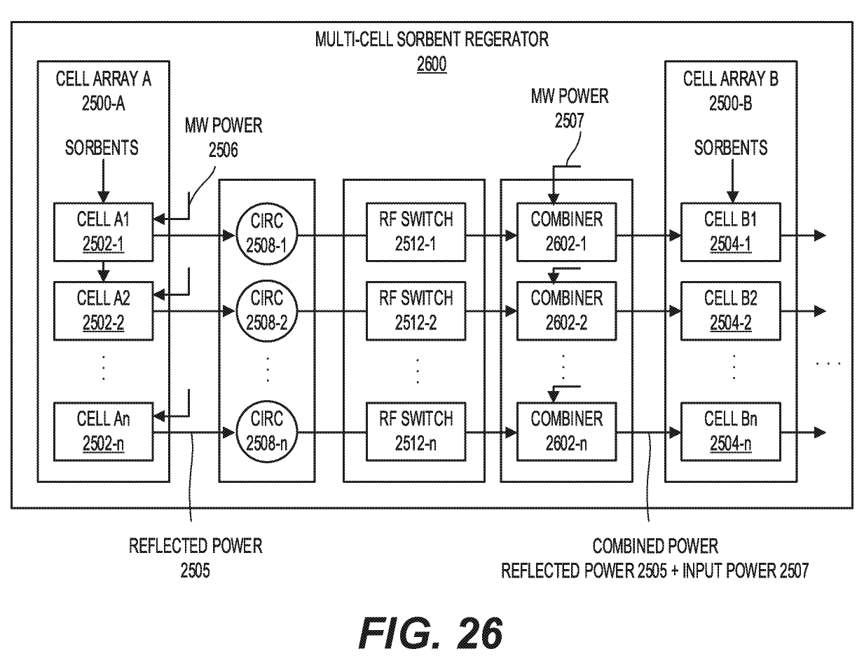

Reference is made to FIGS. 25-26. FIG. 25 depicts a block diagram of an example multi-cell sorbent regenerator 2500 including a plurality cell arrays 2500-A to 2500-N, and including circulators 2508-1 to 2508-n and RF switches 2512-1 top 2512-n to re-direct reflected power to cells in adjacent arrays. FIG. 26 depicts a diagram of an example multi-cell sorbent regenerator 2600 including a plurality cell arrays 2500-A to 2500-N, and including power combiners 2602-1 to 2602-n to re-direct reflected power to cells in adjacent arrays. It should be understood that the example multi-cell sorbent regenerator 2500 and 2600 may include additional features and that some of the features described herein may be removed and/or modified without departing from the scope of the multi-cell sorbent regenerator 2500 and 2600.

FIG. 25 depicts a block diagram of an example multi-cell sorbent regenerator 2500 connected in a multi-cell configuration. The multi-cell sorbent regenerator 2500 may include a plurality of cell arrays 2500-A to 2500-N. Each cell array may include a plurality of sorbent regenerators connected in series to process sorbent structures. Within each cell array, the cells may be assigned a level, for instance, the first cell is level 1 and the next cell is level 2, and so on. Each cell array may have correlated levels. In this regard, the cells in each level across the cell arrays may be tuned for the same resonant frequency and type of sorbent material. For example, the cell A12502-1 and the cell B12504-1 may both be level 1 cells, and hence may be tuned for the same resonant frequency and sorbent material. The multi-cell sorbent regenerator 2500

The multi-cell sorbent regenerator 2500 may include circulators 2508-1 to 2508-n and RF switches 2512-1 to 2512-n to re-direct reflected power to a same-level cell in the adjacent cell array to minimize energy loss and maximize energy efficiency. For example, the circulator 2508-1 and the RF switch 2512-1 may re-direct reflected power from cell A12502-1 in cell array A to cell B12504-1 in cell array B. Connections across different-level cavities may not be compatible and may cause reflected power, as each cavity level is optimized to process a different sorbent and may operate at different resonant frequencies. In some examples, the RF switch 2512 may be used to block power reflection from cell array B to cell array A for advanced control.

In the multi-cell sorbent regenerator 2500, the reflected power 2505 from cell array A may be not combined with the input power 2507 for cell array B. The reflected power 2505 is separately introduced to cell array B using RF switch 2512-1. This means the cell arrays A and B may be operated with controlled synchronization to maximize energy efficiency. The introduction of the power combiner allows the reflected power 2505 and the input power 2507 to be combined. As depicted in FIG. 26, the power combiner 2602-1 may combine the reflected power 2505 from cell array A with the input power 2507 for cell array B.

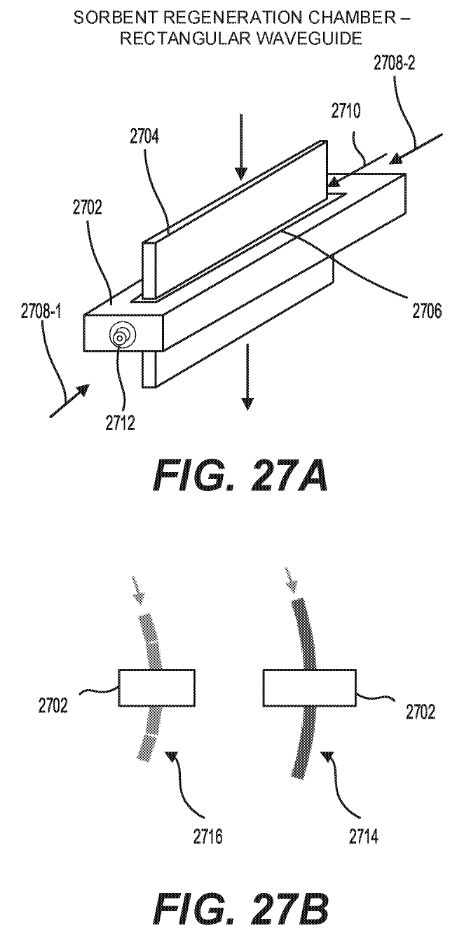

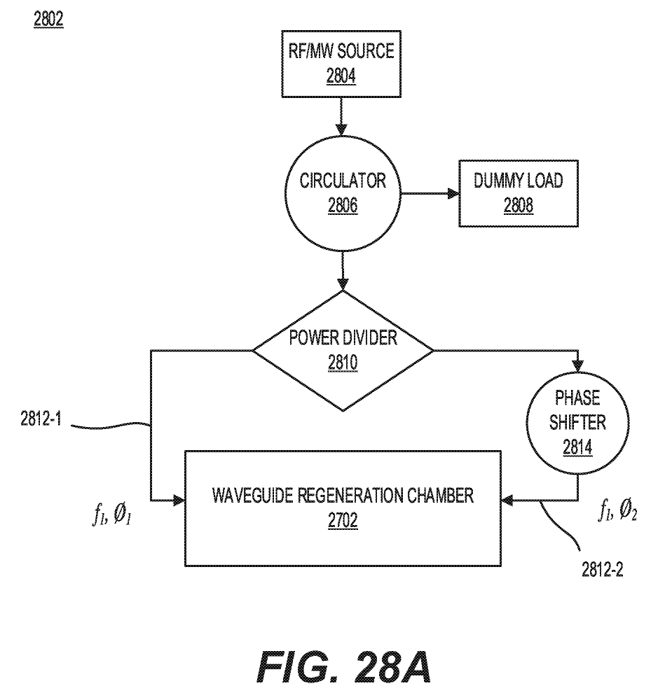

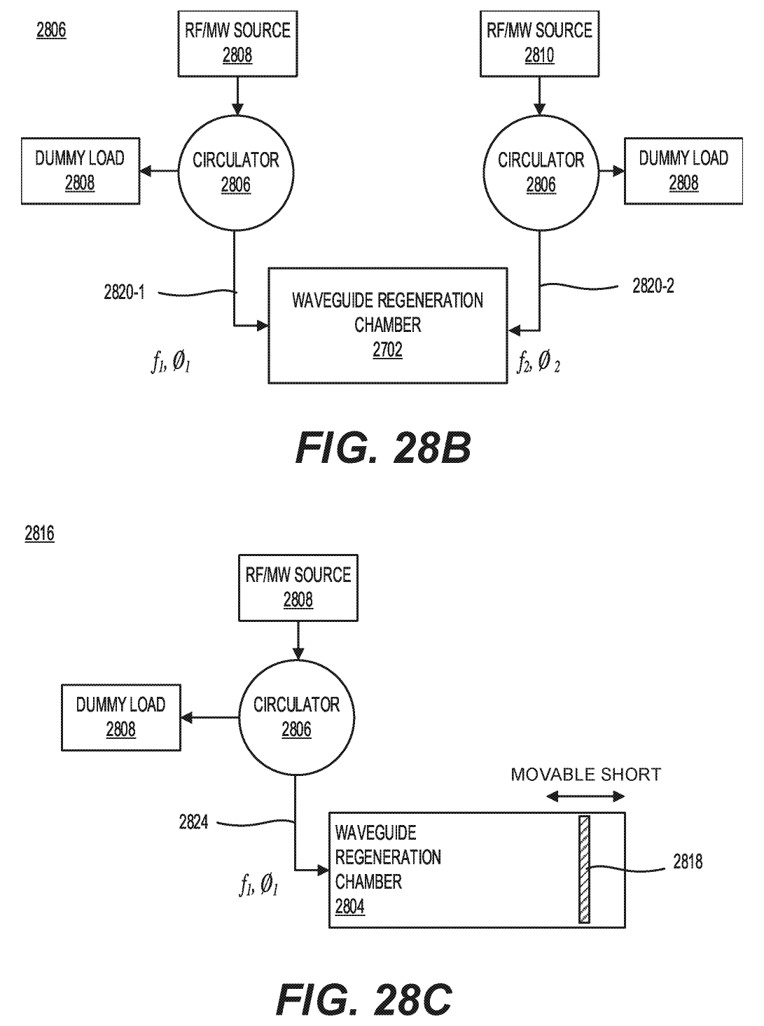

Reference is made to FIGS. 27A to 27B and FIGS. 28A to 28C. FIG. 27A depicts a 3-dimensional perspective view of an example sorbent regeneration chamber 2702 having a rectangular waveguide 2704. FIG. 27B depicts a diagram of an example curved sorbent structure 2714, 2716 for a waveguide sorbent regeneration chamber 2702. FIG. 28A depicts a block diagram of an example sorbent regenerator 2802 having a waveguide regeneration chamber 2702 and an input power source 2804. FIG. 28B depicts a block diagram of an example sorbent regenerator 2806 having a waveguide regeneration chamber 2702 and multiple input power sources 2808, 2810. FIG. 28C depicts a block diagram of an example sorbent regenerator 2812 having a waveguide regeneration chamber 2702 with a moving short 2814. It should be understood that the example sorbent regeneration chamber 2702 and the sorbent regenerator 2802, 2806, 2812 may include additional features and that some of the features described herein may be removed and/or modified without departing from the scope of the sorbent regeneration chamber 2702 and the sorbent regenerator 2802, 2806, 2812.

FIG. 27A depicts a diagram of an example sorbent regenerator chamber having a waveguide regeneration chamber. The sorbent structure 2704 may have a rectangular panel shape. The sorbent structure 2704 may be a long, thin panel or a thin plate. In some examples, the sorbent structure 2704 may be the same as the sorbent structure 102 depicted in FIG. 2A and the sorbent structures 902, 908, 910, 912, and 914 depicted in FIGS. 9A to 9C.

The sorbent structure 2704 may enter and exit the rectangular waveguide regeneration chamber 2702 through openings 2706 on the top and the bottom of the waveguide regeneration chamber 2702. The openings 2706 may be positioned along the center in a lengthwise direction along arrow 2710. The strength of the electromagnetic energy and the peak amplitude of the electric field may be the greatest along the centerline for this type of rectangular waveguide. A feeding mechanism (not shown) may feed the sorbent structure 2704 through the openings 2706 at a constant speed or at a variable speed profile. In some examples, the rectangular waveguide

The waveguide regeneration chamber 2702 may enable a single-mode application and may focus the electric field near the center of the structure. The dimensions of the waveguide regeneration chamber 2702 may be tailored for source frequencies. The height of the waveguide regeneration chamber 2702 may be tailored to control the amplitude of the electric field. In some examples, both ends of the waveguide regeneration chamber 2702 may have an input port 2712 for connection to RF/MW sources. In some examples, multiple waveguide regeneration chamber 2702, or waveguide applicators, may be stacked for sorbent processing in sequence. Power leakage through openings 2706 may be negligible.

The waveguide regeneration chamber 2702 may include a feedline (not shown). The feedline may be a channel having a rectangular shape correlated to the shape of the sorbent structure 2704. The feedline may guide the sorbent structure 204 through the center of the chamber, while reducing the overall volume for vacuum pressure. The feedline may also further minimize any energy losses through the opening.

FIG. 27B depicts a diagram of a curved sorbent structure 2714, 2716 for the sorbent regeneration chamber 2702. The curved sorbent structure 2714 may be curved such that rotation of the curved sorbent structure 2714, 2716 causes the sorbents to move in and out of the waveguide regeneration chamber 2702. In some examples, the curved sorbent structure 2714, 12716 may have a large ring shape, or a circular shape, in which the ring may continuously rotate in one direction. In this case, another part of the ring may be coupled to an air contactor. In some examples, the ring shaped sorbent 2716 may be a collection of multiple smaller sorbent structures that are connected together. The ring shaped sorbent 2714 may be made in one piece.

FIG. 28A depicts a block diagram of an example sorbent regenerator 2802 having a waveguide regeneration chamber 2702 that receives two power inputs 2812-1 and 2812-2, which may have the same frequency and different phases. A circulator 2806 and a dummy load 2808 is connected to the energy source 2804. The circulator 2806 may protect the energy source 2804 from any power that is reflected back from the waveguide regeneration chamber 2702, particularly during late stages of desorption when the dielectric properties of the sorbent material begin to change. The waveguide regeneration chamber 2702 has two input ports 2712 on either end of the waveguide regeneration chamber 2702. A power divider 2810 may be connected to the circulator 2806 to divide the power for the two input ports 2712 into power inputs 2812-1 and 2812-2. A phase shifter 2814 may disposed at one of the input ports 2712 to shift a phase of the power input 2812-2. Phase shifting the input power 2812-2 may enable movement of the standing wave in the resonant cavity, and hence enable some adjustability in the regions of the sorbent structure 2704 to be heated.

FIG. 28B depicts a block diagram of an example sorbent regenerator 2806 having a waveguide regeneration chamber 2702 that receives two power inputs 2820-1 and 2820-2 from two energy sources 2808 and 2810. The two power inputs may be independent from each other, such that each power input may receive energy that has different magnitudes, frequencies, and phases. Each of the two energy sources 2808 and 2810 may be connected to a circulator 2806 and dummy load 2808 for protection.

FIG. 28C depicts a block diagram of an example sorbent regenerator 2816 having a waveguide regeneration chamber 2804 that receives one power input 2824 from a single energy source 2808. However, the sorbent regenerator 2816 may have a moving short 2818, also referred to herein as a sliding short or a shorting plate, installed in the resonant cavity of the sorbent regenerator 2816. The moving short 2818 may change the tuning, and hence the behavior of the standing wave and the locations of hotspots as well as cold spots. The moving short 2818 may enable tuning without structural alterations to the waveguide. The moving short 2818 may be made of a metal material, such as a metal plate, a metal mesh, or the like. A sliding mechanism may be installed to enable movement of the moving short 2818. In some examples, the sliding mechanism may be automated to automatically vary the heat distribution and the locations of hotspots and cold spots on the sorbent material.

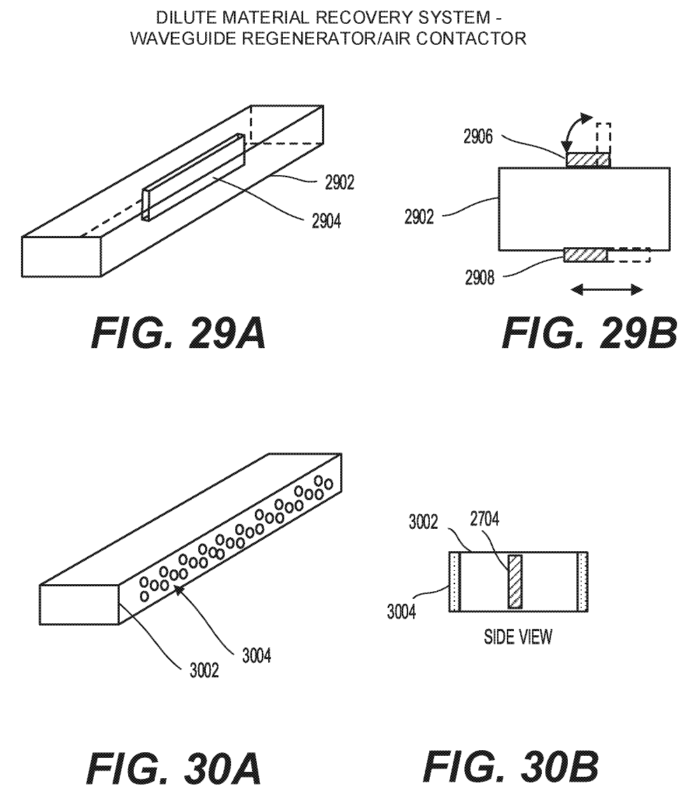

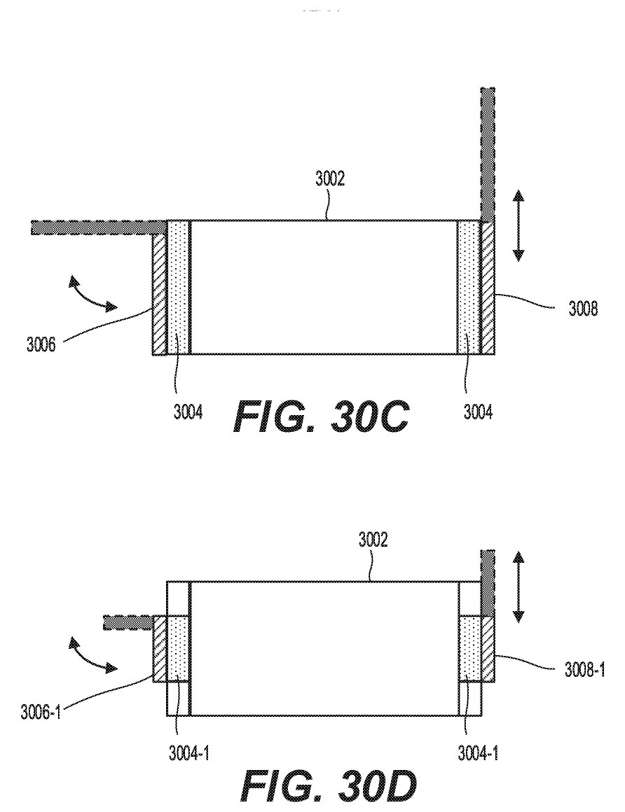

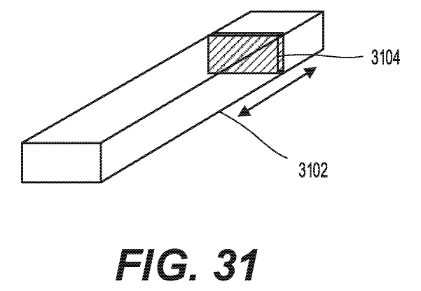

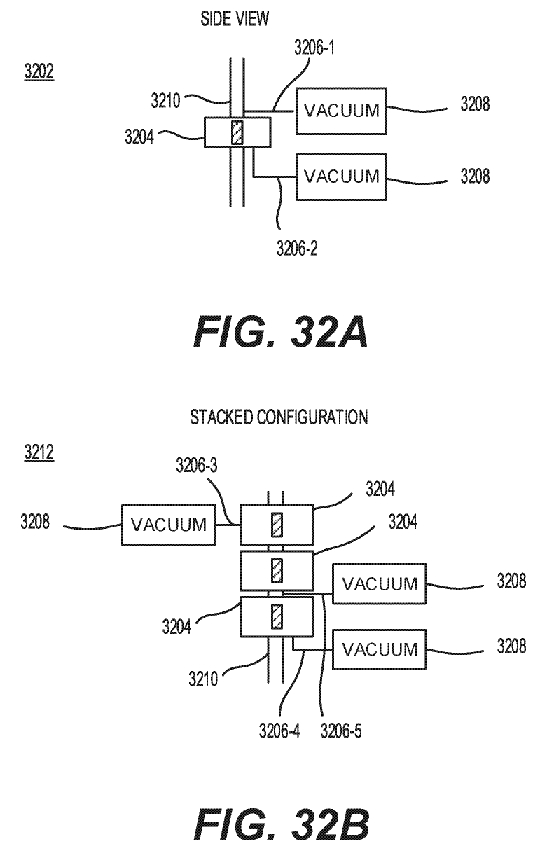

Reference is made to FIGS. 29A to 29B, FIGS. 30A to 30B, and FIGS. 32A to 32B. FIG. 29A depicts a 3-dimensional perspective view of an example waveguide regeneration chamber 2902. FIG. 29B depicts a side view of an example waveguide regeneration chamber 2902 that includes vacuum-compatible doors 2906, 2908 for the sorbent structure 2904. FIG. 30A depicts a 3-dimensional perspective view of an example waveguide regeneration chamber 3002 that includes a perforated wall 3004 for ambient airflow. FIG. 30B depicts a side view of an example waveguide regeneration chamber 3002 that includes a perforated wall 3004. FIG. 30C depicts a side view of an example waveguide regeneration chamber 3002 that includes air contactor doors 3006, 3008 for a perforated wall 3004. FIG. 30D depicts a side view of an example waveguide regeneration chamber 3002 that includes air contactor doors 3006-1, 3008-1 for a partially perforated wall 3004-1. FIG. 31 depicts a 3-dimensional perspective view of an example waveguide regeneration chamber 3102 that includes a moving short 3104 for tuning the waveguide regeneration chamber 3102. FIG. 32A depicts a diagram of an example sorbent regenerator 3202 having a waveguide regeneration chamber 3204, in which a plurality of vacuum lines 3206 are connected near a resonant cavity. FIG. 32B depicts a diagram of an example stacked sorbent regenerator 3212 having a plurality of waveguide regeneration chambers 3204 stacked together, in which a plurality of vacuum lines 3206 are connected near a resonant cavity. It should be understood that the example waveguide regeneration chamber 2902, 3002, 3102 and the sorbent regenerators 3202, 3212 may include additional features and that some of the features described herein may be removed and/or modified without departing from the scope of the waveguide regeneration chamber 2902, 3002, 3102 and the sorbent regenerators 3202, 3212.

FIG. 29A depicts a waveguide regeneration chamber 2904. The waveguide regeneration chamber 2904 may be referred to herein as a sorbent regeneration chamber or a rectangular waveguide sorbent regeneration chamber. The waveguide regeneration chamber 2904 may have similar features as the sorbent regeneration chamber 2702, however, unlike the sorbent regeneration chamber 2702 that allows the sorbent structure 2704 to feed through the waveguide, the waveguide regeneration chamber 2904 may fully contain the sorbent structure 2904 inside the vacuum cavity of the waveguide. In this case, the cavity of the waveguide itself may function as a vacuum chamber, negating the need for a separate vacuum cavity.

In some instances, the size of the waveguide cavity may be significantly larger than the size of the sorbent structure 2904. In these instances, an energy penalty may exist to pressurize the larger space. A smaller vacuum chamber that better fits the sorbent structure 2904 may be provided inside the cavity of the waveguide. This smaller vacuum chamber may be similar to a feedline for sorbent structures, and may be made of a RF/MW transparent material, such glass, PTFE, plastics, and/or the like, which are compatible with vacuum pressures.

The waveguide regeneration chamber 2904 may include vacuum seal doors 2906, 2908. The vacuum seal door 2906 may be a hinge type that swings outward, while the vacuum seal door 2908 may be a sliding type that slides to open the chamber. The opening at the doors may be the same as the opening 2706 depicted in FIG. 27A.

FIG. 30A depicts a waveguide regeneration chamber 3002 that operates as both as a regeneration chamber and an air contactor chamber, and may be referred to herein as an integrated contactor-regenerator or an integrated DAC system. The waveguide regeneration chamber 3002 includes perforated walls 3004 formed on sides of the waveguide regeneration chamber 3002. The perforated walls 3004 may function as a faraday cage in which RF/MW waves are contained. The perforated walls 3004 may allow ambient air to flow through the chamber, such that the waveguide regeneration chamber 3002 functions as an air contactor. The material and the size of the holes may be determined to ensure that RF/MW waves do not escape the cavity during desorption, while allowing adequate ambient airflow during adsorption.

FIG. 30B depicts a side view of an example waveguide regeneration chamber 3002 that includes a perforated wall 3004. FIG. 30C depicts air contactor doors 3006 and 3008 to cover the perforated walls 3004. The air contactor doors 3006 and 3008 may be vacuum-compatible for instances where the cavity is to operate under vacuum. The air contactor door 3006 may be a hinge type that swings outward, while the air contactor door 3008 may be a sliding type that slides open to uncover the perforated walls 3004. FIG. 30D depicts air contactor doors 3006-1 and 3008-1 to cover the partially perforated walls 3004-1. The partially perforated walls 3004-1 do not extend the height of the waveguide regeneration chamber 3002. The air contactor doors 3006-1 and 3008-1 are sized to match the partially perforated walls 3004-1. The air contactor door 3006-1 may be a hinge type that swings outward, while the air contactor door 3008-1 may be a sliding type that slides open to uncover the perforated walls 3004.

FIG. 31 depicts a waveguide regeneration chamber 3102 that has a moving short 3104 installed inside the resonant cavity. The moving short 3104 may also be referred to herein as a sliding short or a shorting plate. The moving short 3104 may allow for tuning without physically altering the structure of the waveguide. The moving short 3104 may change the tuning, and hence the behavior of the standing wave and the locations of hotspots and cold spots. The moving short 3104 may be made of a metal material, such as a metal plate, a metal mesh, or the like. A sliding mechanism may be installed to enable movement of the moving short 3104. In some examples, the sliding mechanism may be automated to automatically vary the heat distribution and the locations of hotspots and cold spots on the sorbent material.

FIG. 32A depicts a side view of an example sorbent regenerator 3202 having a waveguide regeneration chamber 3204 and a plurality of vacuum lines 3206 connected to the waveguide regeneration chamber 3204. The desirable connection point would be outside of the waveguide, just near the entrance/exit for the sorbent structure. The waveguide is tuned such that the standing waves are located along the feedline 3210, and hence would correlate to the highest yield of adsorbates, such as CO₂ and H₂O. A vacuum pump 3208 connected at this location would enable collection of CO₂ with the least amount of potential contaminants. The vacuum line 3206-1 is connected to the feedline 3210, just outside the waveguide or cavity wall. The vacuum line 3206-2 is connected through the body of the waveguide, near the feedline 3210. A connection at these points near the feedline 3210 may ensure that the vacuum lines are connected at the point of peak desorption, near the center of the resonant cavity.

FIG. 32B depicts a stacked sorbent regenerator 3212 that includes three waveguide regeneration chambers 3204 stacked together. In this case, some areas may be difficult to access so drilling through the waveguide walls may be needed. In order to attach the vacuum line 3206-3, a hole may be drilled through the metallic wall of the waveguide to access the inner cavity. If multiple vacuum lines are to be connected, they should be connected at opposite ends of the stack to ensure optimal gas capture. For instance, the vacuum line 3206-4 is connected to the stack opposite the vacuum line 3206-3. A size of the hole may be adjusted for gas conductance or flow and for RF/MW power leakage prevention. A metal mesh may be added to prevent RF/MW power leakage without blocking gas flow through the waveguide. In some examples, the vacuum line 3205-5 may be connected on the feedline 3210, between two waveguides.

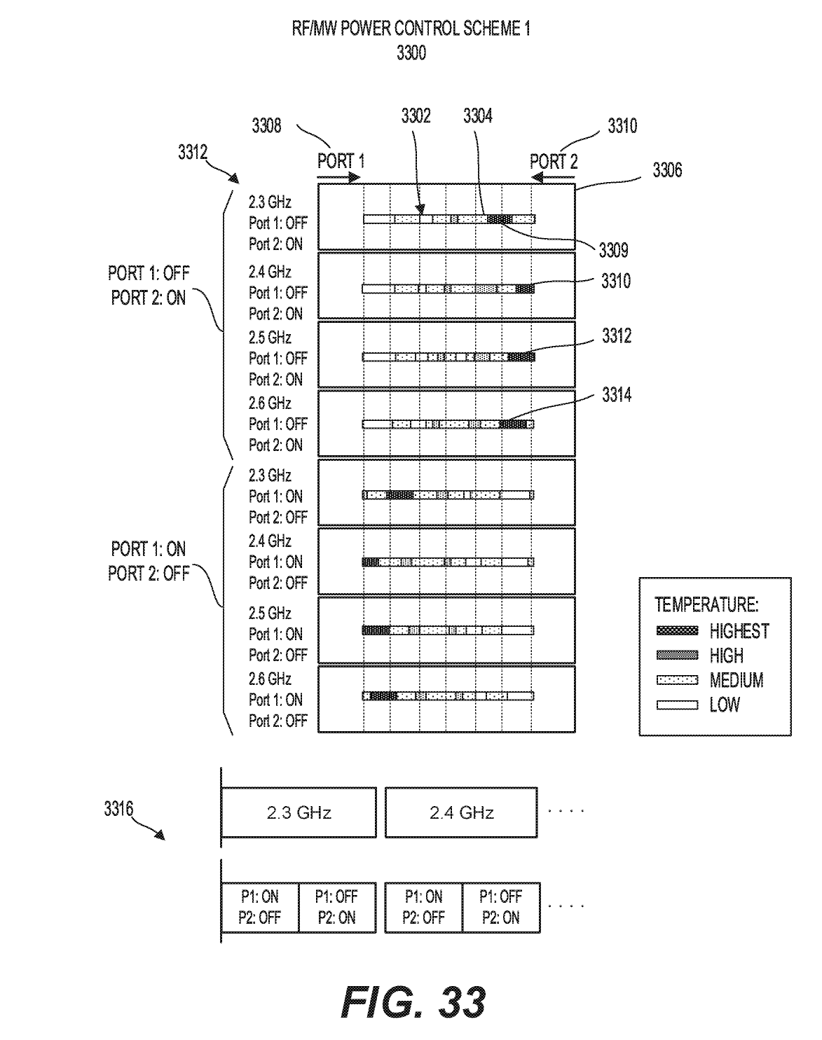

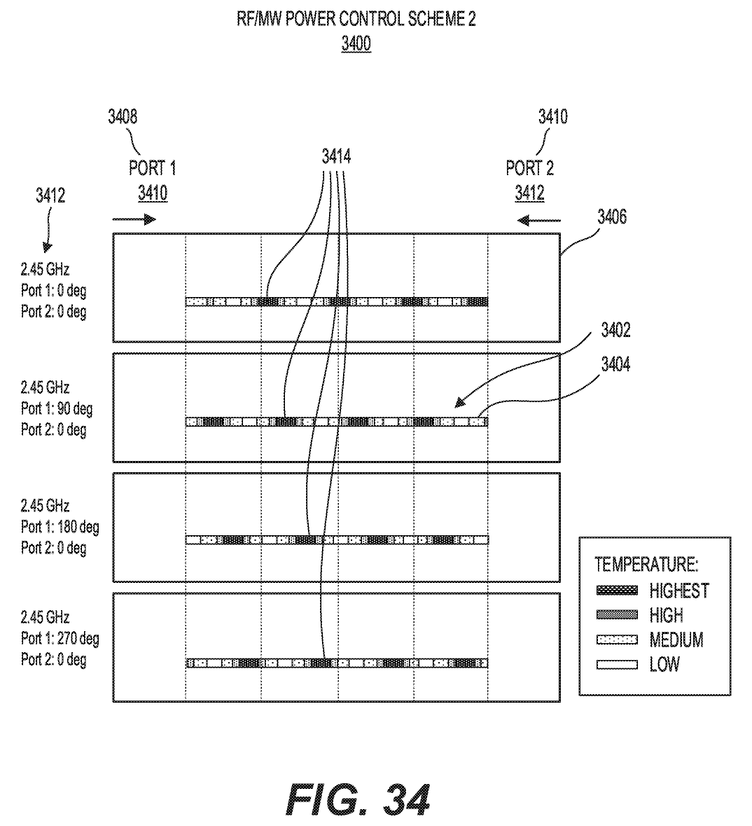

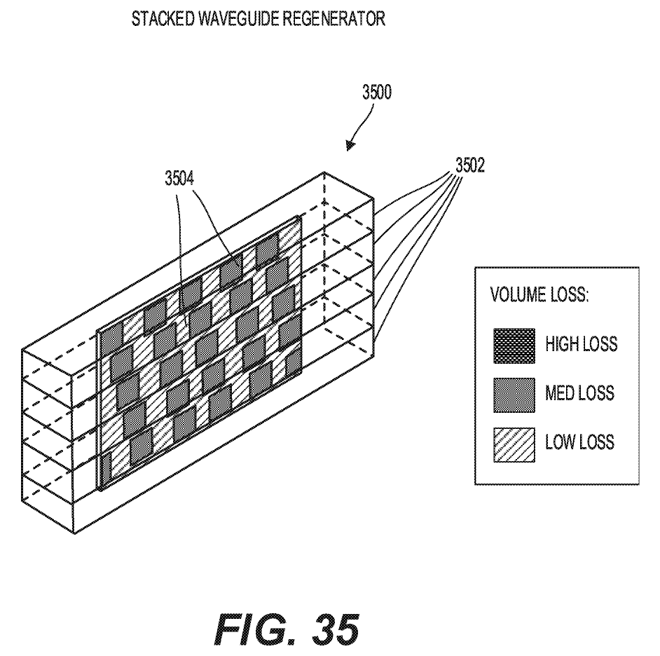

Reference is made to FIGS. 33 to 35. FIG. 33 depicts a diagram of a heat map 3302 of a sorbent structure 3304 illustrating an example power control scheme 3300 for a sorbent regenerator having a waveguide regeneration chamber 3306 that includes multiple power input ports 3308, 3310. FIG. 34 depicts a diagram of a heat map 3402 of a sorbent structure 3404 illustrating an example power control scheme 3400 for a sorbent regenerator having a waveguide regeneration chamber 3406 that includes multiple power input ports 3408, 3410, based on phase cycling scheme 3412. FIG. 35 depicts a 3-dimensional perspective view of an example stacked waveguide regenerator 3500 that includes multiple waveguides 3502 stacked together. It should be understood that the example power control scheme 3300, 3400 for a waveguide regenerator and the stacked waveguide regenerator 3500 may include additional features and that some of the features described herein may be removed and/or modified without departing from the scope of the power control scheme 3300, 3400 and the stacked waveguide regenerator 3500.

FIG. 33 depicts a diagram illustrating an example power control scheme 3300 for a sorbent regenerator having a waveguide regeneration chamber 3306, including input signal 3312 control for multiple power input ports 3308, 3310. A diagram of a heat map 3302 of the sorbent structure 3304 illustrates the effects of changes to the input signal 3312. Multiple operational strategies may be implemented to uniformly treat the volume of the sorbent structure 3304.

The power control scheme 3300 may include a combination of incremental or discrete input frequency shifting, and power input from one or both ports 3308, 3310. By way of particular example for purposes of description, one example simulation was performed. The MW frequency incrementally changed at 0.1 GHz interval and 1 W of MW power was applied from one port, either port 1 or port 1, at a time at a time. Through a combination of frequency and input port sweep, the entire volume of the sorbent structure 3306 was uniformly heated. The heating profile as illustrated by the heat map 3302 may be used as a proxy for desorption uniformity. The frequency sweep steps may be electronically controlled, including continuous sweeping. The power input may be electronically controlled, specifically power input may be switched between port 1 and 2, as well as simultaneous power input through both ports.

FIG. 34 depicts a diagram illustrating an example power control scheme 3400 for a sorbent regenerator having a waveguide regeneration chamber that includes multiple power input ports 3410, 3412, based on phase cycling. The power control scheme 3400 includes applying the same frequency from both ports 3410, 2412 simultaneously while shifting the phase from one port, for instance from port 13408. Input power from both ports were at 2.45 GHz. The phase in port 13408 may be cycled from 0, 90, 180, 270, and 360, as per signal input pattern 3412. The change in phase changes the location of the hot spot 3414 on the sorbent structure 3404, eventually treating the entire volume uniformly after phase cycling. In some examples, the phase cycling may be electronically controlled. The input frequency may be fixed or changed within a range compatible with the waveguide.

FIG. 35 depicts a 3-dimensional perspective view of an example sorbent regenerator 3500 including multiple stacked waveguides 3502. The multiple waveguide regenerators 3502 may be ‘stacked’ on top of each other. Each waveguide regenerator 3502 may operate in at different power levels, frequencies, and/or phases to handle changing dielectric properties of the sorbent material as it desorbs. A high degree of controls may be possible, which may maximize uniformity across the sorbent structure 3504, and minimize energy loss while being able to handle a wide variety of sorbent materials with dissimilar dielectric properties. The spacing between the waveguide regenerators 3502 may be tuned. The power leakage through the openings, or slits, may be negligible.

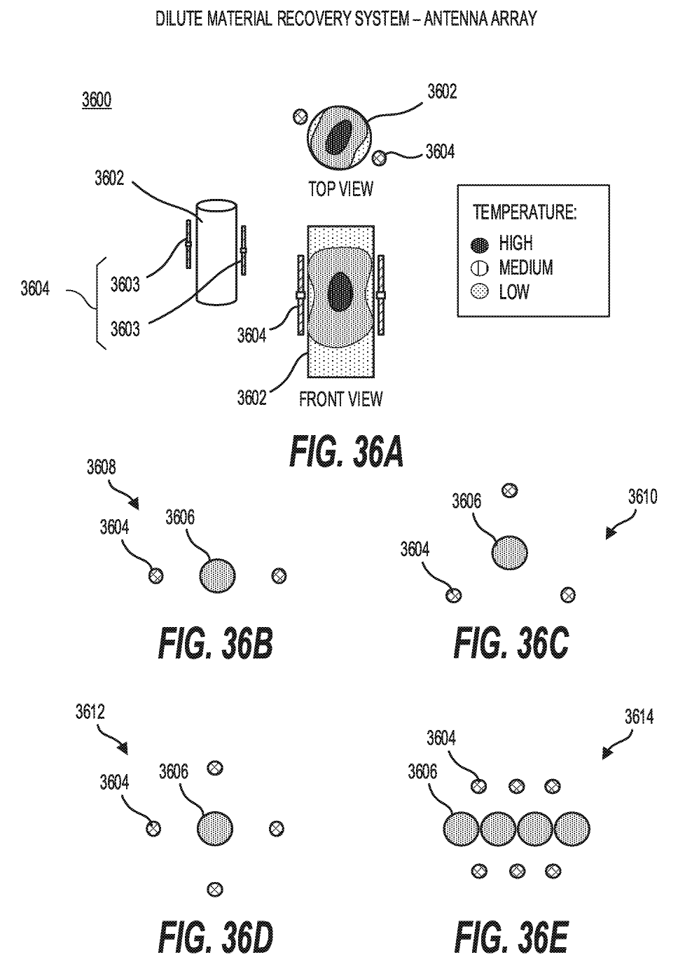

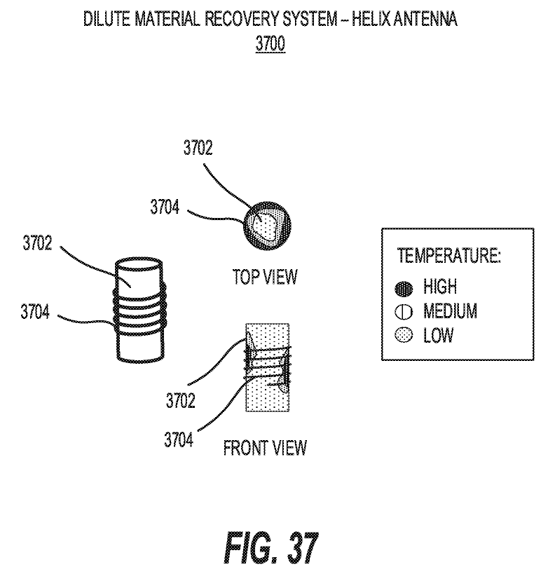

Reference is made to FIGS. 36A to 36E and FIG. 37. FIG. 36A depicts a diagram of an example sorbent regenerator 3600 having an antenna array 3604 and a heat map representative of the energy distribution in the cylindrical sorbent structure 3602. FIG. 36B depicts a diagram of an example antenna array 3608 having two antennas 3604 around a sorbent structure 3606. FIG. 36C depicts a diagram of an example antenna array 3610 having three antennas 3604 surrounding a sorbent structure 3606. FIG. 36D depicts a diagram of an example antenna array 3612 having four antennas 3604 surrounding a sorbent structure 3606. FIG. 36E depicts a diagram of an example antenna array 3614 having six antennas 3604 surrounding a group of four sorbent structures 3606. FIG. 37 depicts a diagram of an example sorbent regenerator 3700 having a helix antenna 3704 and a heat map representative of the energy distribution in the sorbent structure 3702. It should be understood that the example sorbent regenerators 3600, 3700 and antenna arrays 3604, 3608, 36103612, and 3614 may include additional features and that some of the features described herein may be removed and/or modified without departing from the scope of the sorbent regenerators 3600, 3700 and antenna arrays 3604, 3608, 36103612, and 3614.

FIG. 36A depicts a diagram of an example sorbent regenerator 3600 having an antenna array 3604. The antenna array 3604 may include two or more antennas 3603 to form an array. An antenna array 3604 may produce relatively uniform heating rate across the volume of a cylindrical sorbent structure 3602. Each antenna 3603 may be powered by a single or multiple energy sources, with or without a phase controller. This may provide multiple degrees of freedom to control the electric field distribution that may be tuned to the dielectric properties of the sorbent material. As illustrated by the heat map, higher heating rates near the center of the cylindrical sorbent structure 3602 may be realized.

FIGS. 36B to 36E depict various antenna array configurations. The antenna array 3608 has two antennas 3604 that surround a sorbent structure 3606. The antennas 3604 may be dipole antennas, which may be positioned equidistance from the sorbent structure, directly opposite each other. The antenna array 3608 may be the same as the antenna array 3604 depicted in FIG. 36A. FIG. 36C depicts the antenna array 3610, which has three antennas 3604 surrounding a sorbent structure 3606. FIG. 36D depicts the antenna array 3612 having four antennas 3604 surrounding a sorbent structure 3606. FIG. 36E depicts a diagram of an example antenna array 3614 having six antennas 3604 surrounding a group of four sorbent structures 3606. In each of these antenna arrays, the antennas may positioned evenly around the sorbent structure 3606 to ensure even distribution of electromagnetic energy on the sorbent structure 3606.

FIG. 37 depicts a diagram of an example sorbent regenerator having a helix antenna 3704. The helix antenna 3704 may have higher heating rates near the edge of the cylindrical sorbent structure 3702, and hence, may complement dipole antenna arrays since they have higher heating rates at the center of the sorbent structure 3602. In some examples, the antenna arrays 3604, 3608, 3610, 3612, 3614 and the helix antenna 3704 may be stacked, similar to the sorbent regenerators with flared cavities and waveguide-based reactors as previously described.

Although described specifically throughout the entirety of the instant disclosure, representative examples of the present disclosure have utility over a wide range of applications, and the above discussion is not intended and should not be construed to be limiting, but is offered as an illustrative discussion of aspects of the disclosure.

What has been described and illustrated herein is an example of the disclosure along with some of its variations. The terms, descriptions and figures used herein are set forth by way of illustration and are not meant as limitations. Many variations are possible within the scope of the disclosure, which is intended to be defined by the following claims -- and their equivalents -- in which all terms are meant in their broadest reasonable sense unless otherwise indicated.

What is claimed is:

1. A sorbent structure comprising:
a sorbent material formed to have a 3-dimensional shape comprising a plurality of protrusions, the sorbent material to adsorb a compound from ambient air that passes through the sorbent structure and desorb the adsorbed compound in response to electromagnetic energy being radiated at the sorbent material, wherein the plurality of protrusions distribute the electromagnetic energy into the sorbent structure to reduce reflection of the electromagnetic energy incident on the sorbent structure and evenly dissipate the incident electromagnetic energy within the sorbent structure.

2. The sorbent structure of claim 1, wherein the plurality of protrusions have a predetermined shape and are arranged in a predetermined pattern.

3. The sorbent structure of claim 2, wherein the plurality of protrusions have a pyramid shape, a side surface of the pyramid shape having a predetermined angle and a predetermined length based on a type of the sorbent material.

4. The sorbent structure of claim 3, wherein the plurality of protrusions having the pyramid shape are arranged in a grid pattern.

5. The sorbent structure of claim 2, wherein the plurality of protrusions have a triangular prism shape, each of the plurality of protrusions being arranged parallel to each other along a lateral face of the triangular prism shape.

6. The sorbent structure of claim 1, wherein the sorbent structure has a rectangular shape, the plurality of protrusions being disposed on a surface of the rectangular shape.

7. The sorbent structure of claim 1, further comprising a casing having the 3-dimensional shape including the plurality of protrusions, wherein the sorbent material is disposed inside the casing.

8. The sorbent structure of claim 1, wherein the sorbent material adsorbs carbon dioxide (CO₂) from the ambient air that passes through the sorbent structure and desorbs the CO₂ in response to microwave energy being radiated at the sorbent structure to regenerate the sorbent material.

9. A dilute material recovery system comprising:
a sorbent structure having sorbent material, the sorbent structure comprising a plurality of protrusions;
a chamber; and
an energy source disposed to emit electromagnetic energy at the sorbent structure to regenerate the sorbent structure,
wherein the plurality of protrusions distribute the emitted electromagnetic energy evenly into the sorbent structure to reduce reflection of the electromagnetic energy incident on the sorbent structure.

10. The dilute material recovery system of claim 9, further comprising:
an air contactor; and
a conveyor belt connected between the air contactor and the chamber, the sorbent structure being mounted to the conveyor belt to move between the air contactor and the chamber.

11. The dilute material recovery system of claim 9, further comprising:
a cell arranged in an array of cells, wherein the cell comprises the chamber, the sorbent structure fixed inside the chamber, and the energy source fixed to the chamber.

12. The dilute material recovery system of claim 9, wherein the plurality of protrusions have a pyramid shape, a side surface of the pyramid shape having a predetermined angle and a predetermined length based on a type of the sorbent material.

13. The dilute material recovery system of claim 10, wherein the plurality of protrusions have a pyramid shape and are arranged in a grid pattern on the sorbent structure.

14. The dilute material recovery system of claim 10, wherein the plurality of protrusions have a triangular prism shape, each of the plurality of protrusions being arranged parallel to each other along a lateral face of the triangular prism shape.

15. The dilute material recovery system of claim 9, wherein the sorbent structure comprises a casing to accommodate the sorbent material, the plurality of protrusions being formed on a surface of the casing to shape the sorbent material disposed inside the casing.

16. The dilute material recovery system of claim 9, wherein the sorbent structure comprises a porous substrate and CO₂-capturing moieties, the CO2-capturing moieties being coated on a surface of the porous substrate.

17. The dilute material recovery system of claim 9, wherein the sorbent structure adsorbs carbon dioxide (CO₂) from ambient air that passes through the sorbent structure, and the energy source emits microwave energy at the sorbent structure to desorb the CO₂ to regenerate the sorbent material.

18. The dilute material recovery system of claim 9, wherein the chamber comprises:
at least one vacuum-compatible door that allows movement of the sorbent structures into and out of the chamber, wherein the at least one vacuum-compatible door is to hold vacuum pressures inside the chamber during microwave application;
metallic surfaces that contain electromagnetic radiation inside the chamber; and
at least one non-metallic window that allows transmission of the electromagnetic energy into the chamber.

19. A microwave-based continuous-flow dilute material extraction system comprising:
a sorbent material;
an air contactor; and
a sorbent regenerator, comprising:
a regeneration chamber; and
an energy source disposed to emit microwave energy at the sorbent material in the regeneration chamber; and
a tube connected between the air contactor and the sorbent regenerator to transport the sorbent material between the air contactor and the sorbent regenerator, wherein the sorbent material is disposed inside the tube to continuously circulate between the air contactor and the sorbent regenerator.

20. The microwave-based continuous-flow dilute material extraction system of claim 19, wherein the sorbent material comprises solid sorbents or a liquid solvent,
wherein the solid sorbents are formed to have a spherical shape or a cylindrical shape, the solid sorbents being porous to allow gasses to pass through the sorbent material, and
wherein the liquid solvent comprises sorbents that are suspended in aqueous or non-aqueous solutions to focus the microwave energy on the suspended sorbents while the liquid solvent continuously circulates inside the tube.
